(19) United States
(12) Patent Application Publication
(10) Pub. No.: US 2026/0236493 A1
(43) Pub. Date: Aug. 13, 2026

(54) Methods and Systems for Tokenising Structured Language

(71) Applicant: Imagination Technologies Limited, Kings Langley (GB)

(72) Inventors: Sergei Chirkunov, London (GB); James Stuart Imber, Hemel Hempstead (GB); William Peter Keen, Cambridge (GB); Daniel Wilkinson, Bristol (GB)

(21) Appl. No.: 19/430,409

(22) Filed: Dec. 23, 2025

(30) Foreign Application Priority Data
Dec. 23, 2024 (GB) 2419021.7

(51) Int. Cl. G06F 16/31

(52) U.S. Cl. CPC G06F 16/313

(57) ABSTRACT

A structured language for use in a language model is tokenised. Each segment of the structured language includes a plurality of words formed using a predetermined syntax. A segment structure embedding of a received segment is determined by identifying, based on the predetermined syntax, a word-category for each word in the segment, thereby obtaining a sequence of word-categories; determining a category-token value for the sequence of word-categories; and encoding the category-token value as a vector defining the segment structure embedding. Word embeddings are determined by, for each word in the segment: determining a word-token value for the word; and encoding the word-token value as a vector. A unique vector embedding is determined by combining i) the vector defining the segment structure embedding and ii) each vector defining each word embedding of the word embeddings, wherein the unique vector embedding uniquely defines the received segment and is arranged to be input into language model.

### CROSS-REFERENCE TO RELATED APPLICATIONS AND CLAIM OF PRIORITY

This application claims foreign priority under 35 U.S.C. 119 from United Kingdom patent application No. GB2419021.7 filed on 23 Dec. 2024, the contents of which are incorporated by reference herein in their entirety.

### TECHNICAL FIELD

The present disclosure relates to the field of language modelling using machine learning methods and systems, and in particular for a tokeniser configured for use with language models such as transformer (e.g. GPT) neural networks for statistical modelling of program code. Such applications may include generation of new program code.

### BACKGROUND

As part of the process of designing and implementing microprocessor/CPU architectures into silicon, it is important to verify the operation of the hardware. Verifying the operation of microprocessor cores is an essential step to help ensure that the (definition of the) silicon hardware behaves as intended (e.g., as defined in its Instruction Set Architecture (ISA)) for legal instructions, and various sequences of such instructions. One method of verification is performed by generating randomised assembly code for the CPU core to execute. One type of microprocessor architecture of particular interest is that which uses a ‘Reduced Instruction Set Computer’ (RISC) instruction set.

Typically, humans build programs to generate randomised assembly code for verification and testing purposes. This is referred to as “Random Instruction Sequence” (RIS) generation. The primary purpose of the verification code is to test as many legal instructions as possible. This is because the purpose of verification and testing is to expose bugs (i.e., breaches of the software/hardware contract as defined by the intended instruction set) that may be triggered by running a particular sequence of instructions. Since any subsequent behaviour of hardware depends on its current state and a current instruction, it is important to produce a sequence containing only legal instructions. The generated stimulus thus helps to test whether a CPU handles sequences of legal instructions as intended. Moreover, it is also desirable to be able to generate a sequence of legal instructions which itself is capable of being executed without errors. The so-called ‘state space’ of given hardware implementing a given ISA would be prohibitively large to explore to completion. Thus, it would also be desirable to be able to selectively generate sequences of (legal) instructions to target desired areas of the state space, i.e., where there is reason to suspect bugs may exist.

In CPU verification, the primary aim can be summarised as follows: to ensure the software/hardware contract, as defined in the Instruction Set Architecture (ISA), is followed in its entirety by the CPU product. There are three pillars of verification for any CPU design project: stimulus, checkers and coverage. Stimulus represents test vectors, i.e., inputs to the hardware design in a simulation environment, which attempt to expose bugs by reaching many and diverse states in the hardware state space. An objective of creating good quality ‘stimulus’ is to provide a diverse and unbiased (i.e., devoid of human bias) set of stimulus code. ‘Checkers’ are the components that notice where a bug occurs if/when it is exposed by the Stimulus. ‘Coverage’ is the means of assessing what architectural state space has actually been tested in the design and comprises static/structural coverage and functional coverage.

A primary objective for CPU designers is to improve the reliability and stability of CPU architectures. Consequently, a corresponding objective is to search for ways to improve the quality of verification methods. Stimulus must be of a high quality, or else states in the design that represent deviations from the specification will never be reached. Checkers must be of a high quality, or else bugs will never be noticed and flagged. Coverage also must be of a high quality, or else there would be no means by which to assess the quality of the stimulus. Traditionally, code for use in the above three pillars of verification (with the exception of static coverage) has been generated by programs handwritten by engineers. Consequently, one problem with code used for traditional verification methods is that it suffers from human bias, i.e., since the verification code is limited by what can be conceived by human engineers or generated by hand-engineered, automated tools with human input.

A possible solution to the problem of mitigating/eliminating human bias in verification code is to use generative artificial intelligence (AI) to create verification code. Generative language models already exist which can, for example, generate novel continuations of text. However, one significant problem with known language models is that they contain a large number of parameters and are based on an enormous vocabulary (e.g., over 100K tokens), and thus are expensive and difficult to train and inference. Training is problematic in itself: e.g., huge computing/GPU resources are needed with a large amount of memory, and convergence is very slow. As a consequence of the large size of many known language models, they are very slow and resource-intensive to inference. However, for CPU verification, it is desirable that verification can be performed at ‘interactive rates’ on commodity inference hardware such as a desktop GPU, or on remote inference hardware such as a server-hosted GPU. In other words, inference should be fast enough to enable a human to interact with the output, use it for verification purposes, and alter the input parameters/conditions to generate a new output. This degree of interactivity enables an efficient iterative testing process. Verification engineers typically use commodity GPU or CPU hardware, and so it is desirable that language models for verification purposes are efficient. Such efficient language models are currently lacking in the field.

A second significant problem with known language models is that program code is not as well represented well in the dataset of text used to train transformer (e.g., GPT models) language models and other large language models (LLMs) compared to other types of text. However, even the portion of corpus of training data that is code is substantially weighted towards more ‘popular’ languages, e.g., C or Python. Thus, the type of code typically used for verification and testing purposes, i.e., assembly language (ASM) code, is even more poorly represented. To make matters worse, some assembly, e.g., x86 assembly, is much better represented than open source instruction sets such as RISC-V. Consequently, the output of LLMs used to generate ASM would be poor (especially so for RISC-based ASM), even if they could be made fast enough to use at interactive rates. Put another way, a large portion of the vocabulary of known LLMs would not be useful for assembly language generation, since assembly is under-represented. In general, and separately from the problems associated with the task of ASM representation in the training corpus, even including a larger body of ASM would not necessarily improve matters, because it is difficult if not impossible to predict and disable the parts of a vocabulary which will be ‘inactive’ for a given ASM dialect. Thus, in general, using a large vocabulary (even one that contained a significant amount of ASM data) would be statistically inefficient, and thus will result in greater complexity, power consumption, and inference time of the network.

A third significant hurdle to using known GPTs, for the purposes of generating verification code, is the method of tokenisation currently employed. All language models require tokenisation to convert human-readable text to indices corresponding to vectorised embeddings suitable for further processing. Tokenisation plays a crucial role in model efficiency and accuracy as it determines how data is presented to, and interpreted by, the model. Tokenisation therefore has a bearing on what aspects of data are considered salient. In previous examples in the literature, tokenisation may generate indices from characters, word pieces, words, sentence fragments, sentences, or a combination of multiple levels.

A common tokenisation method is byte pair encoding (BPE). BPE is an algorithm that learns statistically likely tokens based on a corpus of text. BPE does this by iteratively combining commonly occurring contiguous sequences of characters to form larger character groups, including whole words. Thus, BPE learns a vocabulary of tokens that combines single character tokens, word fragments, whole words, and even compound words. BPE is thus suitable for a language containing thousands or hundreds of thousands of words with commonly occurring fragments, but is wholly unsuitable for formal, structured languages, e.g., computer code, which have few words but strict syntax and grammar requirements. BPE, and generally no known method of tokenisation for language models, can guarantee the generation of legal instructions. This is because BPE can only statistically infer the structure of an instruction. Due to the fragmentary nature of the tokens learned by BPE, legal instructions cannot be enforced in the input or output of a language model. In the case of assembly languages, for example, with a statistical tokeniser like BPE it would be possible to construct strings from the induced vocabulary which lie outside the valid set defined by the ISA, which would be highly undesirable since the objective is to produce only legal ASM instructions. In other words, by default, BPE cannot guarantee the correctness of the syntax of a structured language, such as ASM.

Moreover, an inherent feature of BPE is that the size of a given output token will vary, as tokens have many different sizes, and represent different portions of words. This creates another problem for language models (in particular those based on statistical tokenisers), as it is often advantageous to fix the size of the input for a neural network. More specifically, it is advantageous to increase the amount of information that is available to the model for a given size of fixed context window. The output of a language model is a single token considered by the language model to represent a likely continuation of the input sequence. If BPE, or another statistical tokeniser, were used for creating assembly instructions it would not be straightforward to fix the number of instructions available in the context window as input for a language model, because tokens used by BPE are statistically chosen and vary in length, meaning that a language segment (e.g. assembly instructions) does not necessarily correspond to a fixed number of tokens. Even more problematically, not only will the tokens likely be smaller than a whole (ASM) instruction, but the number of fragments (tokens) making up a whole instruction will be variable.

Various language models are known that have been developed specifically to generate code. However, all still suffer from problems that render them unsuitable for code verification methods. In one respect, the tokenisation methods of known code-generating models suffer from the same or similar problems to those outlined above. Known language models used for code generation are not necessarily designed from the outset to produce strictly correct code, or instructions. This is because they are commonly used as productivity aids for humans, who will ultimately ensure and/or be responsible for the accuracy of the code. However, problems the present disclose aims to solve (which include but are not limited to verification and testing problems) require correct sequences of code to be generated. Another problem is that many known code-generating methods are trained on large corpora of human-written source code. This mostly includes high-level languages such as such as C++ and Python. These types of language models may be helpful in productivity, e.g., assisting software engineers to produce code more efficiently or accurately. However, because they are not trained primarily on machine-level code, e.g., assembly language used for verification purposes, they are of reduced value for CPU verification methods. Language models that are specifically adapted to producing assembly code still suffer from at least some of the aforementioned problems, e.g., the tokenisation methods are still unsuited to generating unbiased and legal assembly code (especially those that use BPE tokenisation).

It is an objective of the present disclosure to provide a solution to at least the aforementioned problems, for example the problems associated with language models and in particular methods of generating, understanding, and/or tokenising a formal/structured language such as program code. It is also an objective of the present disclosure to provide new solutions beyond generative methods application, for example, methods of classifying formal/structured languages.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

There is provided a method of tokenising a structured language for use in a language model. The structured language is formed of segments and each segment comprises a plurality of words formed using a predetermined syntax.

According to a first aspect there is provided a method of tokenising a structured language for use in a language model, wherein the structured language is formed of segments, and wherein each segment comprises a plurality of words and is formed using a predetermined syntax, the method comprising:
receiving a segment to tokenise;
determining a segment structure embedding of the received segment by:
   identifying, based on the predetermined syntax, a word-category for each word in the received segment, thereby obtaining a sequence of word-categories;
   determining a category-token value for the sequence of word-categories;
   encoding the category-token value as a vector defining the segment structure embedding;
determining one or more word embeddings by, for each of one or more words in the segment:
   determining a word-token value for the word; and
   encoding the word-token value as a vector defining a word embedding;
determining a unique vector embedding by combining i) the vector defining the segment structure embedding and ii) each vector defining each word embedding of the one or more word embeddings, wherein the unique vector embedding uniquely defines the received segment and is arranged to be input into language model.

In example implementations, the structured language is a computer code language. The computer code language may be formed of segments, and a plurality of segments may form an instruction for the computer code language. In some examples, the method may involve receiving a whole instruction of the computer code, formed of a plurality of segments, to tokenise. The method may also involve inputting the unique vector embedding into the language model.

According to another aspect, there is provided a method of tokenising a structured language for use in a language model, wherein the structured language is a computer code language formed of segments, and wherein each segment comprises a plurality of words and is formed using a predetermined syntax, the method comprising:
receiving a segment to tokenise, wherein the segment corresponds to a whole instruction of the computer code language;
determining a segment structure embedding of the received segment by:
   identifying, based on the predetermined syntax, a word-category for each word in the received segment, thereby obtaining a sequence of word-categories;
   determining a category-token value for the sequence of word-categories;
   encoding the category-token value as a vector defining the segment structure embedding;
determining one or more word embeddings by, for each of one or more words in the segment:
   determining a word-token value for the word; and
   encoding the word-token value as a vector defining a word embedding;
determining a unique vector embedding by combining i) the vector defining the segment structure embedding and ii) each vector defining each word embedding of the one or more word embeddings, wherein the unique vector embedding uniquely defines the received segment; inputting the unique vector embedding into the language model.

In example implementations, the language model is preferably a generative language model. For example, the generative language model may be a transformer-based generative language model. In implementations, the generative language model is a generative pre-trained transformer, GPT, model.

In example implementations, the unique vector embedding is configured to be interpretable by the language model to thereby enable the language model to determine a structure of the segment and the words comprised within the segment.

In example implementations, the language model is a generative language model configured to generate one or more new segments in dependence on the unique vector embedding.

In example implementations, each of i) the vector defining the segment structure embedding, and ii) each vector defining each word embedding, are substantially orthogonal, and wherein determining the unique vector embedding comprises linearly combining each of i) the vector defining the segment structure embedding, and ii) each vector defining each word embedding

Thus, in some examples, a dimension of the unique vector embedding may also be equal to the dimension of the vector defining the segment structure embedding and the dimension of each vector defining each word embedding. In implementations, a dimension of the vector defining the segment structure embedding, and a dimension of each vector defining each word embedding of the one or more word embeddings, is equal.

In example implementations, determining the unique vector embedding comprises:
applying a linear transformation to each of i) the vector defining the segment structure embedding, and ii) each vector defining each word embedding to obtain a plurality of transformed vectors, wherein each linear transformation is different;
linearly combining the plurality of transformed vectors to obtain the unique vector embedding.

In example implementations, a matrix defining each of the different linear transformations is orthogonal or substantially orthogonal. In examples, the matrices defining the respective different linear transformations comprise randomly selected values.

In example implementations, a number of words comprised within the segment is equal to or less than a predetermined segment word-limit defined by the structured language.

In example implementations, a tokeniser vocabulary is defined by a number of different possible combinations and permutations of word-categories for a segment, and wherein the tokeniser vocabulary is less than a number of possible segments formable within the structured language. Thus, in some examples, the maximum possible number of segments formable within the structured language is equal to the number of different possible combinations and permutations of words forming the segment.

In example implementations, each word of the plurality of words is either a string or a number. In example implementations, for a word in the segment that is a string, determining the word-token value for the string comprises:
determining the word-token value for the string;
encoding, using a word embedding function, the word-token value to obtain a first intermediate embedding;
encoding, using a number embedding function, the word-token value to obtain a second intermediate embedding, wherein the second intermediate embedding represents a special token indicating that an identity of the work-token is outside a vocabulary of the number embedding function;
combining the first intermediate embedding and the second intermediate embedding to obtain the vector defining the word embedding. For example, combining may comprise linear addition of the intermediate embeddings.

In example implementations, for a word in the segment that is a number, determining the word-token value for the number comprises:
partitioning digits of the number into a plurality of subsections, each subsection comprising one or more characters;
for each subsection of the plurality of subsections, obtaining a word-token value for the subsection and encoding, using a number embedding function, the word-token value for the subsection into an intermediate tensor of values;
combining each tensor of values, for each subsection, to obtain the vector defining the word embedding for the number. In example implementations, the word-token value for each subsection is encoded and combined in the order of most significant bit to least significant bit of the number.

In example implementations, the method further comprises: encoding, using a word embedding function, the word-token of the subsection to obtain an intermediate embedding representing an unknown token value; and combining the intermediate embedding representing the unknown token value with the vector defining the word embedding for the number.

In example implementations, the received segment is part of a sequence of segments, wherein determining the unique vector embedding further comprises: encoding a position of the received segment within the ordered sequence to obtain a vector representing a position embedding; and combining the position embedding with i) the vector defining the segment structure embedding and ii) each vector defining each word embedding of the one or more word embeddings.

In example implementations, the method further comprises: determining, for each segment in the ordered sequence of segments, a unique vector embedding to thereby obtain a plurality of unique vector embeddings; inputting the plurality of unique vector embeddings into the language model; and obtaining, from the language model, a generated segment, wherein the generated segment comprises a plurality of words arranged using the predetermined syntax.

In example implementations, the method further comprises:
obtaining, from the language model, an output vector representing a probability distribution over a tokeniser vocabulary, wherein the tokeniser vocabulary is defined by a number of different possible combinations and permutations of word-categories for a segment;
determining a word-category to bias in the generated segment;
in dependence on the word-category to bias, selecting a subset of values of the output vector, wherein the subset of values define segments comprising at least one word in the word-category to exclude;
obtaining an adjusted output vector by adjusting a probability value of each value in the subset of values in dependence on a bias indication;
determining the generated segment by sampling the adjusted output vector. In implementations, the word-category to bias represents a word-category to exclude, wherein obtaining the adjusted output vector comprises setting a probability value of each value in the subset of values to zero. For example, a size of the output vector is equal in size to the tokeniser vocabulary.

In example implementations, determining the generated segment by sampling the adjusted output vector comprises:
obtaining a vector embedding from the language model;
converting the vector embedding into a structural probability distribution representing a structural tokeniser vocabulary, the structural tokeniser vocabulary representing all possible segment structures;
obtaining one or more word embeddings by, for each of the one or more word categories identified in the segment structure:
   applying a linear transformation to the vector embedding to obtain a word embedding, wherein the linear transformation is associated with a position of the word category identified in the segment structure;
obtaining one or more words corresponding to the one or more word-categories by, for each of the one or more word embeddings:
   converting the word embedding into a word probability distribution representing a word vocabulary;
   in dependence on the identified word-category, sample the word probability distribution to obtain a word;
obtaining the segment of the structured language in dependence on the segment structure and the one or more sampled words.

In example implementations, sampling the word probability distribution to obtain a word in dependence on the identified word-category comprises: for each word probability distribution, determining a subset of words that do not belong in the identified word category associated with that word probability distribution; for each word in the subset of words, set a probability to zero to thereby obtain a masked probability distribution; sampling from the masked probability distribution to thereby obtain the word.

In example implementations, each word in the segment has a word-type, wherein the word-type is one of: an operator, an operand, and a number, and wherein each word-type comprises one or more possible word-categories, and wherein the structured language is an assembly language for a CPU, and each segment is a single assembly instruction.

In example implementations, the CPU uses a RISC microprocessor architecture, and wherein each segment is an assembly instruction for the RISC microprocessor architecture. For example, the CPU may be based on a RISC-V microprocessor architecture. In example implementations, an operand is a register, and the operand word-type may include a plurality of word-categories corresponding to a plurality of different register groups. The number may represent a value or a memory location, and so the number word-type may include word-categories of number category and memory locations category.

In example implementations, the predetermined syntax used to form each segment is defined by a list of word-types in a predetermined order. In example implementations, the order for a RISC-V instruction is i) operator ii) operand(s), and iii) number(s), wherein the instruction comprises i) an operator, ii) zero, one or more operands, and iii) zero, one or more numbers.

In example implementations, determining the segment structure embedding is performed using a structure tokeniser, and determining the plurality of word embeddings is performed using a word tokeniser, wherein a token vocabulary of the structure tokeniser comprises all possible combinations and permutations of word-categories for a segment, and wherein a token vocabulary of the word tokeniser comprises all possible operators and operands.

According to a second aspect, there is provided a tokeniser unit for tokenising a structured language for use in a language model, wherein the structured language is formed of segments, and wherein each segment comprises a plurality of words and is formed using a predetermined syntax, the tokeniser unit configured to:
receive a segment to tokenise;
determine a segment structure embedding of the received segment by:
   identifying, based on the predetermined syntax, a word-category for each word in the received segment, thereby obtaining a sequence of word-categories;
   determining a category-token value for the sequence of word-categories;
   encoding the category-token value as a vector defining the segment structure embedding;
determine one or more word embeddings by, for each of one or more words in the segment:
   determining a word-token value for the word; and
   encoding the word-token value as a vector defining the word embedding;
determine a unique vector embedding by combining i) the vector defining the segment structure embedding and ii) each vector defining each word embedding of the one or more word embeddings, wherein the unique vector embedding uniquely defines the received segment and is arranged to be input into a language model.

In example implementations, the tokeniser unit comprises:
a structure tokeniser configured to determine the segment structure embedding; and
a word tokeniser configured to determine the plurality of word embeddings,
wherein a token vocabulary of the structure tokeniser comprises all possible word-categories, and wherein a token vocabulary of the word tokeniser comprises all possible operators and operands.

In example implementations, the tokeniser unit comprises a tokeniser vocabulary is defined by a number of different possible combinations and permutations of word-categories for a segment, wherein the tokeniser vocabulary is less than a number of possible unique vector embeddings.

According to another aspect, there is provided computer readable code configured to cause any of the methods disclosed herein to be performed when the code is run.

According to another aspect, there is provided a computer readable storage medium having encoded thereon computer readable code configured to cause any of the methods disclosed herein to be performed when the code is run.

According to another aspect, there is provided an integrated circuit definition dataset that, when processed in an integrated circuit manufacturing system, configures the integrated circuit manufacturing system to manufacture a tokeniser unit according to presently described embodiments.

According to a third aspect, there is provided a method of generating a segment of a structured language using a language model, wherein each segment of the structured language comprises a plurality of words and is formed using a predetermined syntax, the method comprising:
obtaining a sequence of segments of the structured language;
tokenising each of the segments to generate a plurality of unique embeddings, each unique embedding representing one segment, wherein the tokenising comprises, for each segment:
   determining a segment structure embedding of the segment comprising identifying, based on the predetermined syntax, a word-category for each word in the received segment;
   determining one or more word embeddings for a respective one or more words in the segment;
   combining the segment structure embedding and the one or more word embeddings to obtain the unique vector embedding, which uniquely defines the segment;
decoding, by the language model, the plurality of unique vector embeddings;
in dependence on the decoding, determining, by the language model, an output vector representing a probability distribution over a tokeniser vocabulary, wherein the tokeniser vocabulary is defined by a number of different possible combinations and permutations of word-categories for a segment;
determining a word-category to bias in a generated segment;
in dependence on the word-category to bias, selecting a subset of values of the output vector, wherein the subset of values define segments comprising at least one word in the word-category to bias;
obtaining an adjusted output vector by adjusting a probability value of each value in the subset of values;
determining the generated segment by sampling the adjusted output vector.

According to a fourth aspect, there is provided a method of tokenising a language segment for use in a language model, wherein the structured language is formed of segments, and wherein the language segment comprises a plurality of words, the method comprising:
receiving a segment to tokenise;
determining one of a plurality of word-embeddings by, for each word in the segment:
   determining a word-token value for the word; and
   encoding the word-token value as a vector defining a word embedding;
determining a unique vector embedding defining the segment by combining each vector defining each word embedding of the plurality of word embeddings, the combining comprising:
   applying a linear transformation to each vector defining each word embedding to obtain a plurality of transformed vectors, wherein the plurality of transformed vectors belong to a mutually orthogonal or mutually near-orthogonal basis; and
   summing the plurality of transformed vectors to obtain the unique vector embedding, wherein the unique vector embedding uniquely defines the received segment and is arranged to be input into a language model.

According to a fifth aspect, there is provided a method of decoding a vector embedding generated by a language model to obtain a segment of a structured language, wherein the segment of the structured language comprises a plurality of words and is formed using a predetermined syntax, the method comprising:
converting the vector embedding into a structural probability distribution representing a structural tokeniser vocabulary, the structural tokeniser vocabulary representing all possible segment structures;
sampling the probability distribution to obtain a segment structure, wherein the segment structure contains one or more word-categories identified by placeholders;
obtaining one or more word embeddings by, for each of the one or more word categories identified in the segment structure:
   applying a linear transformation to the vector embedding to obtain a word embedding, wherein the linear transformation is associated with a position of the word category identified in the segment structure;
obtaining one or more words corresponding to the one or more word-categories by, for each of the one or more word embeddings:
   converting the word embedding into a word probability distribution representing a word vocabulary;
   in dependence on the identified word-category, sample the word probability distribution to obtain a word;
obtaining the segment of the structured language in dependence on the segment structure and the one or more sampled words.

The tokeniser and/or language model may be embodied in hardware on an integrated circuit. There may be provided a method of manufacturing, at an integrated circuit manufacturing system, a tokeniser and/or language model. There may be provided an integrated circuit definition dataset that, when processed in an integrated circuit manufacturing system, configures the system to manufacture a tokeniser and/or language model. There may be provided a non-transitory computer readable storage medium having stored thereon a computer readable description of a tokeniser and/or language model that, when processed in an integrated circuit manufacturing system, causes the integrated circuit manufacturing system to manufacture an integrated circuit embodying a tokeniser and/or language model.

There may be provided an integrated circuit manufacturing system comprising: a non-transitory computer readable storage medium having stored thereon a computer readable description of the tokeniser and/or language model; a layout processing system configured to process the computer readable description so as to generate a circuit layout description of an integrated circuit embodying the tokeniser and/or language model; and an integrated circuit generation system configured to manufacture the tokeniser and/or language model according to the circuit layout description.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows an overview of a language model used to generate a new language segment, incorporating the tokenisation method according to presently described embodiments;

FIG. 2 shows a detailed schematic of a tokeniser according to presently described embodiments;

FIG. 3 shows a schematic of a numerical tokeniser according to the presently described embodiments;

FIG. 4 illustrates a method of using a generative language model according to presently disclosed embodiments to iteratively generate new language segments;

FIG. 5 illustrates a method of using the presently disclosed tokeniser according to presently disclosed embodiments to mask the output of a language model;

FIG. 6 illustrates a method of decoding an embedding, output by a language model, to obtain a new language segment;

FIG. 7 shows a flowchart illustrating a method of tokenisation according to presently-described embodiments;

FIG. 8 shows a flowchart illustrating a method of using the presently-described tokenisation method with a language model to bias an output in accordance with presently-described embodiments;

FIG. 9 shows a flowchart illustrating a method of decoding an embedding, output by a language model, to obtain a new language segment output in accordance with presently-described embodiments;

FIG. 10 shows a computer system in which a graphics processing system is implemented; and

FIG. 11 shows an integrated circuit manufacturing system for generating an integrated circuit embodying a graphics processing system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

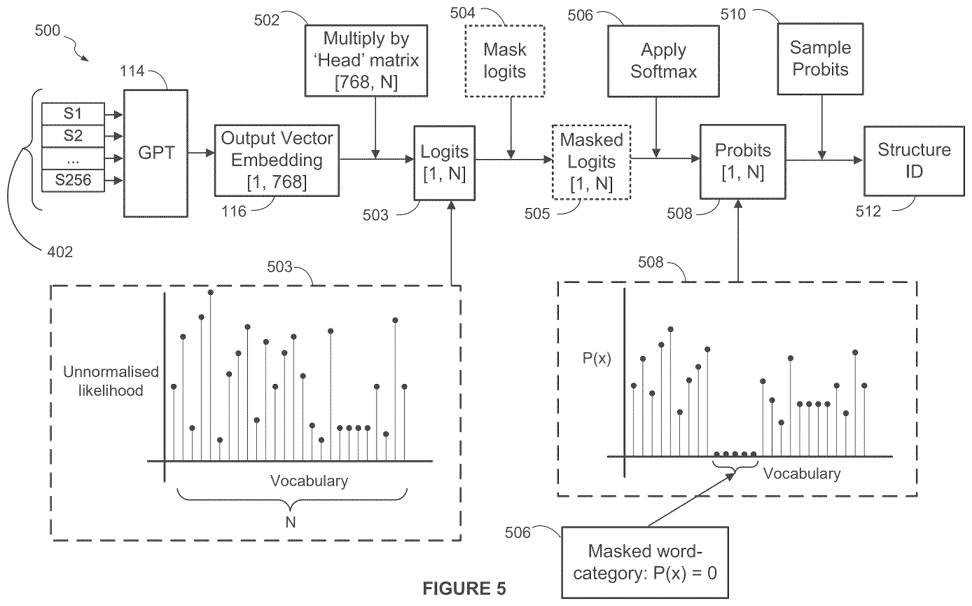

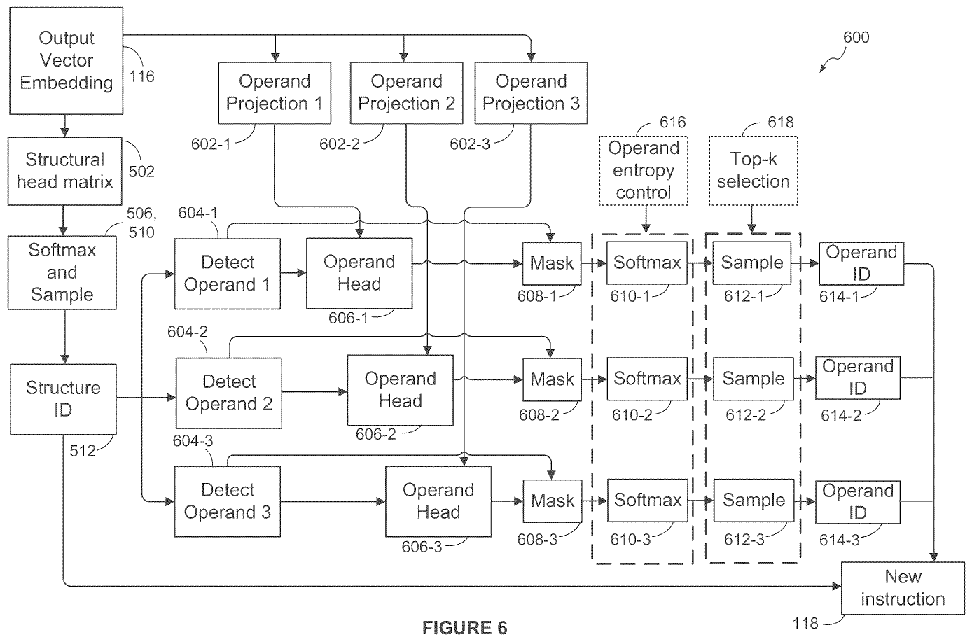

Some terms are used interchangeably in the present disclosure, e.g., depending on context. The term ‘placeholder’ and ‘word category’ refer to the same feature: e.g., the placeholder <args> represents a particular word-category of registers. The term ‘segment’ is used in the general sense to refer to an individual output of a language model (and, equally, an input to the tokeniser). In the context of assembly languages, the term ‘instruction’ is used instead, though it should be appreciated that an ‘instruction’ is merely a specific example of a ‘segment’. An ordered plurality of segments (or instructions) that are used as an input to the tokeniser (or, equally, provided as an output of a language model) may be referred to as a sequence. The term ‘word’ may be used to refer to an individual field within an instruction/segment, where an instruction/segment contains one or more words. In the context of assembly instructions, the terms operator and operand are used to refer to the fields of the instructions, so it should be appreciated that an individual operand or operator is an example of a ‘word’. The concept of ‘masking’ is described (e.g., in respect of FIGS. 5 and 6), which elsewhere in the disclosure is referred to under the umbrella term ‘biasing’ (though biasing encompasses other operations in addition to masking).

In order to solve the aforementioned problems, the inventors have established a new tokenisation method specifically adapted for tokenising assembly language (ASM). One particular use case envisaged by the inventors uses the new tokenisation method to generate output to be consumed by language models (for example, transformer-based models such as GPTs) to generate sequences of ASM. The ability to generate sequences of legal instructions has a plethora of applications, e.g., for hardware verification and testing. For explanatory purposes, and purely in the interests of clarity and brevity, many of the examples in the present disclosure describe tokenisation methods applied specifically to ASM. Even more specifically, some examples refer to ASM used by the RISC-V architecture. However, the presently disclosed tokeniser is applicable more widely to all types of RISC ASM, which is indeed one of the advantages of the presently disclosed tokeniser, i.e., that is it generally applicable to RISC instruction sets. Moreover, the presently disclosed tokeniser is applicable to other types of ASM used by other CPU instruction sets, due to the fact that many assembly languages share the properties of restricted/instruction sizes, restricted formal grammar, and a regular, hierarchical structure. More generally, because the present tokeniser is configured to be particularly suitable for tokenising text that has strict syntax/grammar/vocabulary in an efficient manner, the presently disclosed tokeniser is also suitably applicable for tokenising any kind of structured languages (e.g., high-level computer code instructions/commands, including regular computer languages such as intermediate representations and bytecode for virtual machines) that are formed of segments having some form of predetermined syntax.

It should be appreciated that, although ASM is usually handled in text form (so that humans can understand it), the tokeniser of the present disclosure is not only applicable to textual representation of the ASM. A binary machine-readable encoding could also be converted to the same embedding, for example, which would use bit fields in the instruction corresponding to op code and operands to be parsed, rather than parsing text.

To provide a brief overview of tokenisation, an important initial stage in applying neural networks to language processing methods is the conversion of strings of text into a sequence of numerical vectors that encode the information in a form that is convenient for further processing. A numerical vector generated for this purpose is called an ‘embedding’. The terms ‘embedding’ and ‘vector’ are used interchangeably in this disclosure, though not all vectors referred to are embeddings. An output vector is an embedding or vector output by the language model. The stages involved in the conversion from text string to embedding are outlined as follows:
1) Preprocessing to isolate a string of characters, e.g. by removing excess whitespace;
2) Tokenisation, which splits the string into desired smaller pieces. Each of these smaller pieces is replaced with a corresponding integer value called a token. The token is a predetermined set of characters and is usually represented by an ID or index, which is an integer value that uniquely represents that token. A simple look-up table or token dictionary may be used to convert the string of characters into the token/ID.
3) Embedding, in which each token is converted into vector of values, corresponding to that token's ID (index). This conversion may be facilitated by a lookup table.
   It should be appreciated that, in this disclosure, this whole process comprising steps 1) to 3) may be referred to as tokenisation for simplicity. In other contexts, the term tokenisation has a narrower meaning (i.e., just step 2) above comprising converting a string of characters into a one or more tokens/IDs).

A token vocabulary represents all possible tokens available to a tokeniser, e.g., if the token vocabulary were the alphabet it would comprise 26 tokens. There are practical limitations on the size of a vocabulary of tokens. For example, it would be unfeasible to design a tokeniser that separately encodes each word in the entire English language such that each word has a pre-defined and unique token. Although such a vocabulary would guarantee valid English outputs (i.e., valid, pre-defined English words) such a tokeniser would be highly statistically inefficient. Specifically, it would be computationally/memory inefficient, and very slow to train a machine learning (ML) model on. This is because structures and similarities within and between words are not exposed by the vocabulary, and so would need to be learned entirely by the ML model. Tokenisers whose vocabularies comprise all the words of a language would also be inflexible, because new words would not be representable in terms of existing tokens. Conversely, too fine a scale (e.g. individual letters) makes language modelling error-prone and similarly inefficient, since the network must learn and accurately reproduce the entirety of the language's structure.

Consequently, modern (known) tokenisers have a range of tokens comprising sentence pieces, words, sub-words and characters, which typically are constructed statistically from a corpus (where that corpus may be a large amount of text in one or more languages). These tokenisers are designed to be general-purpose and can process arbitrary sentences in multiple languages. However, in restricted problems such as ASM generation, these general-purpose tokenisers are comparatively expensive to train and inference since the embeddings are not as salient, information-rich, and regular as embeddings hand-engineered for the purpose. Furthermore, state-of-the-art statistical tokenisers such as BPE do not (and cannot) explicitly encode the hierarchy inherent in a language, which then has to be deduced by the language model during training. The present disclosure addresses these shortcomings by (1) introducing a strict mapping between segments of a formal language, and (2) introducing hierarchical sub-tokenisation.

Currently, there are no known tokenisers that are well-suited to the task of encoding assembly language (ASM) for at least the reasons provided above. In summary, most language models use very large vocabularies unsuited to formal languages. In part, this is because LLMs are trained on human-readable text, and so the vocabulary generated by BPE (or any statistical tokeniser) will be biased towards natural language. As a result, such models are highly inefficient for handling ASM data. Moreover, such models have context window limitations. A typical context window length would be 4096 tokens, which would limit the number of ASM instructions to around 400. Statistical fragment-based tokenisers (e.g., BPE) are not suitable, since a BPE-based language model would need to be larger and more expressive (and therefore less efficient) to statistically infer the structure of an ASM instruction, and even once trained, due to the fragmentary nature of the tokens learned by BPE, legal instructions could not be guaranteed in the output. Yet further, the quality of the output would be poorer. For example, using smaller token sizes (e.g., 1-5 characters, as is typical for BPE) would necessarily increase the probability of outputting incorrect instructions, since the instructions would be formed of many small tokens. The quality could be improved by increasing the token size (e.g., 10-20 characters) but at the expense of an exponentially increasing vocabulary size, which means that there will be poor representation of such tokens in the dataset.

It is therefore an objective of the presently disclosed tokeniser to generate a new vocabulary and tokenisation algorithm for efficiently dealing with formal languages such as ASM, and which can guarantee output of legal instructions. Since an objective of the present tokeniser is to guarantee the correctness of instructions using a complete (synthetically constructed) instruction vocabulary, the present tokeniser may also be used to verify the legality of instructions.

For the purposes of this disclosure, a ‘legal’ instruction is one whose grammar and syntax is correct (as defined by the ISA of the CPU) and which is executable by the CPU. It should be appreciated that it is only generally possible to ensure legality at the instruction level, and not the sequence level (a sequence comprising a plurality of instructions in a particular order). In other words, an instruction is either legal or not, however, whether a sequence of (legal) instructions will execute cannot necessarily be predetermined prior to execution. A CPU will attempt to execute any sequence of individually legal assembly instructions, but the sequence overall may not be executable (e.g., it might create an unintentional exception). The present tokeniser is intended to output one instruction at a time, therefore it would be the responsibility of the language model to attempt to provide an executable sequence of instructions given the output of (legal) instructions given to it by the tokeniser.

The inventors have observed that RISC-V assembly instructions have a regular syntax, limited size, and conform to a consistent hierarchical structure. The hierarchical structure, generally, comprises a single operation and up to three arguments, each of which is either a number or a register. ASM operations are sometimes called ‘operators’ and the arguments are sometimes called ‘operands’ in the present disclosure. In other contexts, e.g., other structured languages, similar terminology can be applied, e.g., where a segment of the structured language may comprise a subject (e.g., operator) and one or more objects (e.g., one or more operands).

The motivation of the presently disclosed tokeniser is therefore to provide a hierarchical tokeniser based on this highly regular programming language syntax. The simplicity of the RISC-V syntax is exploited to create a tokeniser that operates on whole instructions whole rather than on pieces of it. This approach ensures that every instruction can be represented as single vector (i.e., a single embedding) rather than an arbitrary and unpredictable number of vectors. Consequently, there is no compute or network capacity wasted on learning the structure of an instruction since the hierarchical structure is baked into the embedding itself. One embodiment of the present tokenizer therefore assumes that every ASM instruction is a combination of an operation, and zero, one, or more operands. In the context of RISC-V, it can specifically be presumed that every instruction comprises an operation and up to three operands (including zero operands).

The same applies well to other types of assembly language, which generally possess some form of hierarchical structure and formal/regular syntax. Thus, other instruction sets that could readily be applied using the hierarchical tokeniser method described herein include Arm and MIPS instruction sets. Some subsets of CISC instruction sets may also be covered in a similar fashion. Although tokenisers currently exist for certain formal languages, including some programming languages, one advantage of the presently disclosed tokeniser is that it is combines multiple sub-tokenisers in a hybrid fashion, including a tokeniser that operates at the level of the structure/syntax of an ASM instruction, such that the entire corpus of instructions can be modelled without explicitly generating a vocabulary for each unique instruction (combination of operators and operands).

However, there are several dozen unique operations in the base ISA of RISC-V and 64 registers (including FP). At least one of the operands may also be a number or memory address, which may be represented using up to 32-bits numbers. Thus, it should be appreciated that tokenising only whole instructions is a highly non-trivial problem. Given the syntax of an assembly instruction, there is an intractable number of combinations. The number of 32-bit values alone is over 4 billion. Ignoring numerical or memory address fields represented by 32-bit values, the number of combinations of operations and registers (presuming only three operands at most) would represent a vocabulary of over 400 k tokens. Consequently, a naïve approach to tokenising all possible instructions would immediately generate a vocabulary of prohibitive size. It is therefore essential to provide a scalable means of encoding a combination of operands, operators, and numbers/memory addresses.

Consequently, the inventors have established that a whole ASM instruction can be tokenised by encoding different aspects of the instruction using individual sub-tokenisers, and then combining the output (i.e., intermediate embeddings) of each of the sub-tokenisers into a final embedding. Specifically, the structure of the ASM instruction is tokenised and embedded, and one or more ‘word’ in the instruction (i.e., of the operator and operand) are separately tokenised and embedded. These intermediate embeddings are then combined. This method exploits the hierarchical nature of ASM instructions by encoding the structure itself into the final embedding. This means that, rather than attempting to construct and use a vast vocabulary that represents all possible combinations and permutations of ASM instructions, the vocabulary can be siloed into smaller sub-vocabularies that are used by the sub-tokenisers.

Separately tokenising the structure of an ASM instruction presents a challenge, due to the many different possible combinations of operators and operands. In order to address this challenge, the operands (i.e., registers) are grouped into categories. For a RISC-V ASM instruction, the instruction can include up to three registers. The possible register values have been grouped into categories based on the RISC-V ISA manual. The following grouping in Table 1 proves only one example of grouping the registers of the RISC-V ISA, where other possible groupings may be equally applicable.

TABLE 1

| Category | Category | |
|---|---|---|
| description | label | Items in category |
| FP Saved | <fp_saved> | fs0, fs1, fs2, fs3, fs4, fs5, fs6, fs7, |
| | | fs8, fs9, fs10, fs11 |
| FP Temps | <fp_tmps> | ft0, ft1, ft2, ft3, ft4, ft5, ft6, ft7, |
| | | ft8, ft9, ft10, ft11 |
| FP args and | <fp_args> | fa0, fa1, fa2, fa3, fa4, fa5, fa6, fa7 |
| returns | | |
| temps | <tmps> | t0, t1, t2, t3, t4, t5, t6, t7 |
| args and returns | <args> | a0, a1, a2, a3, a4, a5, a6, a7 |
| saved | <saved> | s0, s1, s2, s3, s4, s5, s6, s7, s8, s9, |
| | | s10, s11 |

The following categories in Table 2 refer to special purpose registers, and each category has only one item.

TABLE 2

| Category | Category | Items in |
|---|---|---|
| description | label | category |
| Hard-wired zero | <zero> | zero |
| Return address | <ra> | ra |
| Stack pointer | <sp> | sp |
| Global pointer | <gp> | gp |
| Thread pointer | <tp> | tp |

The categories above are used by the high-level structural tokeniser to encode the structure of an ASM instruction. Instead of encoding the actual register names in an instruction, the operands are encoded using the category (or ‘register placeholder) to which that register belongs. For example, all of the registers [fs0, fs1, fs3, . . . , fs11], which belong to the same “FP Saved” group, might be replaced by the same category ‘placeholder’, e.g., “<args>”. As there are only several dozen operators, these are not grouped into categories and are encoded without the use of a placeholder (though, in some implementations, the operators could also be grouped and represented with placeholders, which would further reduce the high-level vocabulary used by the structural tokeniser 107). The method of categorising operands/registers enables the high-level structural tokeniser to encode the underlying structure of any given combination of operations with register categories. Since some register categories are not compatible with certain operations in certain positions in the operand sequence, it is advantageous for the structural tokeniser to be able to represent distinct register categories in this manner, as opposed to having only a single register category/placeholder. Similarly, to address the challenge of encoding a 32-bit number or memory address at the structural level, any 32-bit number or memory address might be replaced with a placeholder, e.g., <num>.

As a result of the high-level encoding, each token represents an operation, and zero, one or more category placeholders (e.g., there may be no categories, e.g. a no-op (nop), but in many cases there will be 3 or 4 categories) comprising register placeholders and/or number/memory placeholders. Since the number of possible combinations of operations and category placeholders is substantially smaller than the number of possible ASM instructions, this advantageously means that the vocabulary used by the high-level structural tokeniser is significantly more manageable. For the example of categories described in the tables above (and the complete set of operators, not shown), the vocabulary size representing all possible category combinations is only 35770 tokens.

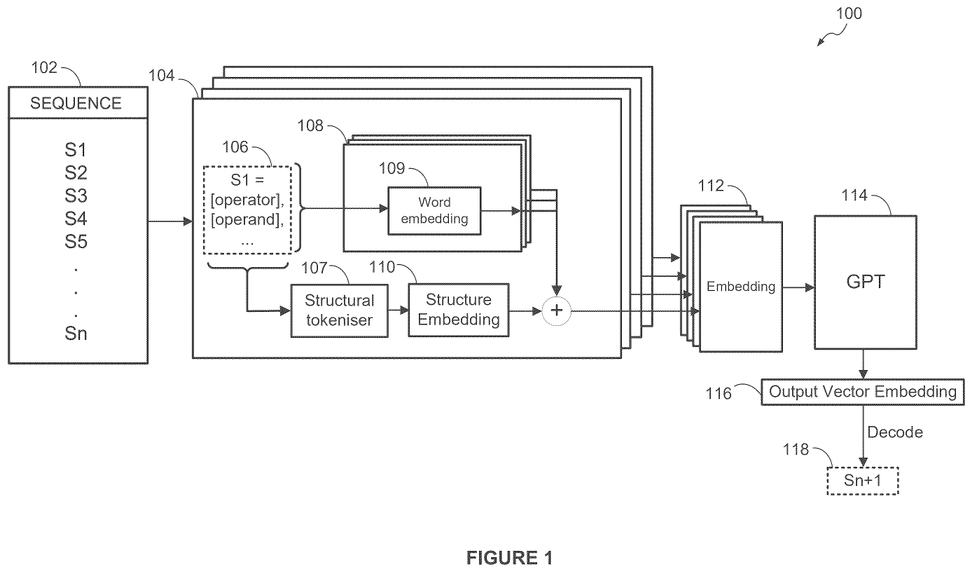

FIG. 1 illustrates an overview of the whole process of using the presently described tokeniser to generate input for a language model to generate a new assembly instruction. In this and other examples in the present disclosure, the language model is a GPT model, though other transformer models and language models in general can be used in conjunction with the present tokeniser. FIG. 1 shows that a history of assembly instructions 102 is used as the input to the model. This sequence of instructions is also called the ‘context window’ 102. Each instruction in the history 102 is individually tokenised by the tokeniser 104 to generate a corresponding high-dimensional vector, with one output vector corresponding to each instruction. These output vectors are the embeddings 112 that are used as the input to the generative model 114. The number of final embeddings 112 will be equal to the number of input instructions in the input sequence 102. Next, the GPT model consumes the embeddings 112 and uses a series of layers to generate an output vector embedding 116. This output vector embedding 116 is then decoded by conversion to vectors representative of one or more probability distributions corresponding to the vocabularies of the structure tokeniser and sub-tokeniser(s), each of which is sampled according to the methods described below to yield the actual RISC-V assembly instruction 118, i.e., represented in a human-understandable string of characters. The final decoded instruction/segment 118 is shown in FIG. 1 as “Sn+1” to indicate that the output is intended to be a likely continuation of the input sequence 102, S1 to Sn. Steps that allow the decoding of the output vector embedding 116 to derive the final instruction/segment 118 are described in respect of FIGS. 5 and 6.

FIG. 1 also illustrates the overall operation of the tokeniser 104 as described above. Each input instruction 106 is separately tokenised. The tokeniser 104 is thus subdivided into a high-level structural tokeniser 107 configured to generate an embedding representing only the structure of the input instructions, and separate word-level tokenisers 108 configured to generate word embeddings 109 for each argument in the instruction. In the example given, the individual components of the input instruction 106, S1, are indicated as [operator], [operand]. The meaning of ‘operand’ should be interpreted broadly, i.e., s number is an example of an operand. At the structural tokeniser 107, the relevant placeholders are obtained for the operand and number, e.g., from a look-up table. The operators are not replaced with placeholders in this case (though they can be) as there are a sufficiently small number of operators such that categorising them is not necessary to make training and inference of the GPT model tractable. The structure of the input instruction 106 is thus tokenised by determining a token representing the combination of the operator, the operand placeholder, and the number placeholder.

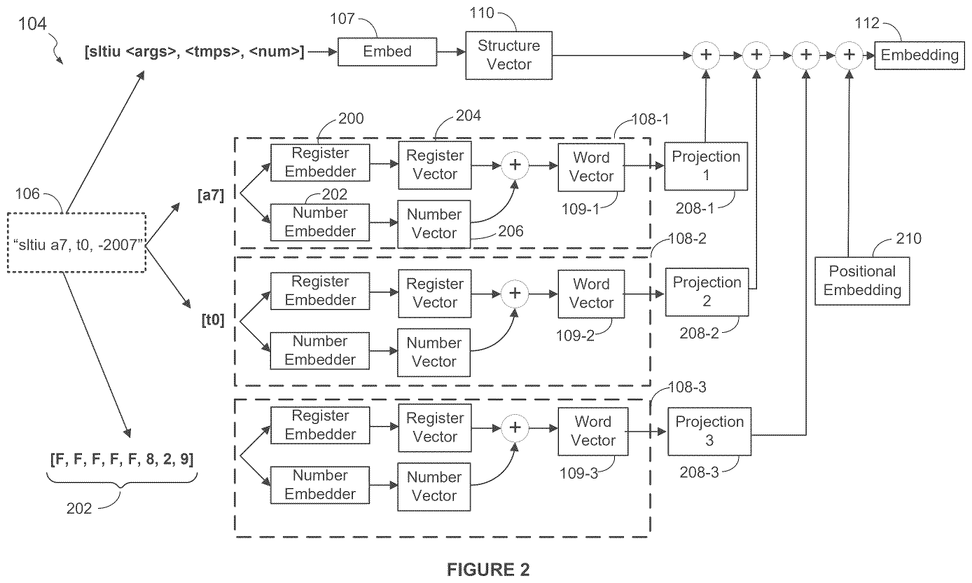

Since the true identity of the operator (i.e., the operator itself, and not a placeholder) is encoded within the structural embedding 110, it does not need to be encoded (specified) by a word-level tokeniser 108. Thus, the word-level tokenisers 108 encode, tokenise and embed the true identity of the operand and number. It will therefore be appreciated that the word-level sub-tokenisers use a different vocabulary than the structural tokeniser 107. For example, the vocabulary of the word-level tokeniser corresponding to a register placeholder for “FP Saved” registers may simply be list of all registers in that category, e.g., as listed in the table above. Given that the word-level tokenisers 108 generate embeddings 109 for individual operands/registers, and not combinations of operands/registers, the size of the vocabulary can be kept small. The intermediate embeddings that are output by the word-level tokenisers 108 are then combined with the structure embedding 110 formed by the high-level tokeniser 107. More than one possibility exists for combining the intermediate embeddings. For example, the intermediate embeddings can simply be concatenated to form a high-dimensional vector whose size (i.e., dimensionality) is equal to the sum of the sizes/dimensions of the intermediate embeddings. A different, more efficient, example of how this combination may be performed is described with respect to FIG. 2. FIG. 1 shows that the intermediate word embeddings are summed, however, the order itself that the word embeddings appear in the input sequence should also be encoded. This can be performed by adding incorporating a positional encoding to each word embedding. In one example, this can be performed by projecting the word embedding using a suitable matrix projection. This is not shown in FIG. 1, but is described in more detail in respect of FIG. 2.

Concerning the embedding of operands by the word-level tokenisers 108, this can be achieved by introducing two additional tokenisation and embedding schemes. The first is a register tokeniser specifically deployed to deal with register values, and the second is a numerical tokeniser specifically to deal with numbers or memory locations (which may each be represented by a 32-bit value). Consistent with the table of register values above, the register tokeniser has a vocabulary of 65 tokens which comprises 64 registers+1 “unknown” special token. The “unknown” token is effectively a placeholder for arguments that do not belong in the vocabulary of the register tokeniser. This token may also be called a “control character”, and may be represented by the placeholder <UNK>. For example, the <UNK> placeholder may be used by a register tokeniser when embedding a number, or an empty space. In the same manner, the numerical tokeniser may use the <UNK> token when given a register value. A specific way of implementing the register and numerical tokenisers is described with reference to FIG. 2.

The presently disclosed tokeniser 104 is specifically engineered to exploit the hierarchical nature of RISC ASM, and is configured to exploit the restricted grammar/syntax of a RISC ISA in order to obtain a fixed encoding rate of 1 ASM instruction:1 token:1 embedded vector. This immediately confers at least three advantages. Firstly, mapping a single ASM instruction to a single token provides greater statistical efficiency, meaning that it is possible to encode a considerably longer sequence of ASM instructions with a given number of tokens than would be possible with an equivalent fragment-based encoder such as BPE. Secondly, this enables a ‘context window’ with a fixed number of instructions. In the present disclosure, the ‘context window’ is the size of the data (e.g., the number of embeddings) that is input to a language model, and from which the language model generates a new token. Since the presently described tokeniser provides a 1:1 mapping from ASM instruction to token, it is possible to guarantee a fixed number of instructions corresponding to the fixed number of final embeddings 112 (each embedding corresponding to a single instruction) in the context window. Thirdly, it removes the scope for invalid instructions to be ingested or generated by the language model, since invalid instructions cannot be constructed out of fragments, thus providing some guarantee of correctness.

The tokeniser outlined in FIG. 1 is therefore advantageously well-suited to being used with a language model, such as a generative pre-trained transformer (GPT) model for the purposes of assembly code generation, for example for microprocessor architecture verification. In a first respect, the proposed tokeniser, in conjunction with a suitable language model, can be used to generate a continuation of a test sequence of ASM instructions, e.g., for a given sequence of ‘true’ instructions generated by a human and known to be valid. This would be useful for improving stimulus quality and targeted coverage around points of interest in the architectural state space. Moreover, stimulus code that explores the architectural state space can be generated and deployed using fewer computing resources, thus significantly reducing engineering effort, computational power requirements and processor time for CPU verification.

Furthermore, the present tokeniser provides various advantages at the level of the tokenisation/embedding. Firstly, the present tokeniser provides improved flexibility for encoding a large body of possible instructions. For example, a new vocabulary could readily be deployed for updated or alternative ASM instruction sets without drastically increasing the number of tokens needed. This is because of the high-level tokenisation step which captures the hierarchical structure of an instruction using a small number of placeholders for registers and numbers/memory addresses. Furthermore, in comparison to BPE encoding which causes complex problems in handling the variable length of context windows, the present tokenisation scheme provides a fixed-rate encoding, which means that the problems arising from fixing the size of the context window are inherently solved. As yet a further advantage, general-purpose models need to identify spaces between words and sentences, and use a special token (e.g., <SEP>) to indicate this. Since the present tokeniser guarantees that each output embedding 112 corresponds to a whole instruction, such special tokens can be avoided altogether since the ‘gaps’ between instructions does not need to be signalled.

The present tokeniser also provides advantageous token efficiency (measured as tokens per word). This provides much better utilisation of the context window since the information encoded in each embedding is very densely and uniformly packed. As a result, much more information is available to the model in any given context window, in a readily usable form. The fact that the structure of whole instructions is mapped within a single embedding 110 also provides the significant advantage that it is possible to directly enforce certain outputs in newly generated instruction whilst maintaining the validity of an instruction. For example, certain registers or operators can be “biased”, or even forcibly included/excluded, by manually steering the sampling to control the new token generation. This level of control is possible due to the fact that the instruction hierarchy and syntax are encoded within the token vocabulary. This method of conditioning code generation (“biasing”) is described in more detail with respect to FIG. 5.

As described above, the method of sub-dividing the tokenisation procedure for whole ASM instructions allows the token vocabulary to be drastically reduced. Doing so not only provides an efficient mapping from whole instructions to single embeddings but generates embeddings that can be utilised by a language model with a high degree of statistical efficiency. However, the problem of combining the intermediate embeddings (109, 110), i.e., those generated by the word-level tokeniser 108 and the structural tokeniser 107, is non-trivial. As mentioned above, it is possible to concatenate the vectors defining the intermediate embeddings 109, 110. However, this could result in an unnecessarily long final embedding vector 112, which could increase the computational cost of executing the network. It should be appreciated that the fundamental advantages of the present tokeniser are still achieved even when the concatenation method is used (e.g., better statistical efficiency, generation of instructions that are guaranteed to be legal, fixed-rate encoding and fixed-size context window etc). Nevertheless, the inventors have established yet more efficient methods of combining intermediate embeddings 109, 110.

The inventors have established a method of linearly combining intermediate vectors by projecting 208 the intermediate vectors prior to linear combination. This advantageously means that the identity of the words or numbers encoded by the intermediate embeddings corresponding to each operand position can be derived from the combined vector. The inventors speculate that this is due to the orthogonality of the projected embeddings. In other words, the orthogonality or near-orthogonality of the projected embeddings ensures that the subsequent combination of vectors is information-preserving and reversible. Surprisingly, despite the computational cost inherent in projecting a high-dimensional vector via an affine transformation (typically a linear transformation), i.e., with a corresponding high-dimensional vector/tensor, the inventors have established that this method of linear combination yields a final embedding 112 with significantly improved statistical efficiency. Moreover, despite the fact that the projection operations requires some computational resource that may be considered higher than typical for a tokeniser, this significantly saves on computational resources later, i.e., when the embedding is input into the language model. Thus, the proposed language model is able to learn the structure ASM instructions efficiently and accurately using final embeddings 112 generated in this way.

FIG. 2 shows a detailed schematic of an example structure for the present tokeniser 104. For explanatory purposes, FIG. 2 represents a worked example of tokenising a specific instruction taken from the RISC-V ISA. In this case, the input instruction 106 comprises an operator, “sltiu”, two register operands, “a7” and “t0”, and one number operand, “−2007”. FIG. 2 illustrates that the structure of this instruction is tokenised separately to obtain a structural embedding 110 (called a “structure vector” in FIG. 2). Each operand is tokenised separately, before the intermediate embeddings 109, 110 are projected 208 and combined.

As a first step, prior to encoding the instruction's structure, the values of the operands are replaced by ‘placeholders’ as described above with reference to the tables of register categories. In the present disclosure, the term ‘word-category’ may be used in place of ‘placeholder’. In this example, it can be seen that the “a7” operand has been replaced by the register placeholder <args>, and the “t0” operand has been replaced by the register placeholder <tmps>. The number, −2007, has been replaced by the generic number placeholder <num>. The set of categories, i.e., “sltiu <args>, <tmps>, <num>” therefore represent a sequence of categories. This replacement instruction, which comprises a sequence of operand categories in place of the operands themselves, is then tokenised. Specifically, the whole string of characters representing the categorised instruction is dealt with as a single token, i.e., “sltiu <args> <tmps> <num>”. This string of characters representing the categorised instruction token is fed into the structural tokeniser 107, which looks up the ID for that token (where the ID is an integer value that uniquely identifies the combination of placeholders). That ID is then converted to an embedding 110 representing the instruction structure. Consequently, the overall vocabulary of the tokeniser represents all possible combinations and permutations of operators and operand categories. It should be appreciated that these combinations and permutations include instructions with fewer than 3 operands, including zero operands.

It can be seen that each operand is embedded and encoded using exactly the same tokeniser structure 108, in that each embedding layer (108-1, 108-2, 108-3) comprises both a register embedding function 200 and a number embedding function 202. Both embedders 200, 202 are deployed in parallel streams irrespective of whether the input string represents a register or a number. In other words, all operands share the same embedding layer 108. It should also be appreciated that the same register embedding function is used for all register categories/placeholders. One reason the same embedding layer 108 is used for all operands (i.e., 108-1, 108-2, 108-3) is to ensure that, once projected and combined, the embeddings can be differentiated from one another in the latent space and processed/interpreted. In other words, the output for each embedding layer 108 is made to be as homogenous as possible. Furthermore, since the same embedding layer is used for each operand, the position of the operand is identified using the projection applied to each embedding layer (108-1, 108-2, 108-3). Specifically, a different and unique projection (208-1, 208-2, 208-3) is applied to each operand. Thus, reach projection is used to encode the relative positions of the operands.

Nevertheless, the operand embedding layers 108 behaves differently depending on whether the input is a register or a number. For the first embedding layer 108-1, and taking the first operand “a7”, this is encoded by the register embedder 200 by the following process:
i. Obtain the instruction;
ii. Extract the operand token, i.e., the relevant string of characters representing the operand, in this case “a7”;
iii. Determine the ID for the operand token (performed by the register tokeniser, 200). The ID is an integer value that uniquely identifies the operand;
iv. Determine a multi-dimensional vector that defines the embedding for that token
   The result of step iv) is thus the “register vector” 204. However, each word-level embedding layer also comprises a numerical tokeniser 202 in a parallel stream. This numerical tokeniser 202 is also configured to embed the operand “a7”. However, the vocabulary of the numerical tokeniser does not contain any registers, and so it outputs the control character <UNK> as a special token that is used to encode out-of-vocabulary tokens. The <UNK> character is then converted to an embedding with a vector representation. Subsequently, the register vector embedding 204 and the number vector embedding 206 (which in this case is representative of the unknown token) are combined by straightforward summation. Thus, the register vector 204, number vector 206, and word vector 109-1 all have the same dimension. In some examples, and in all specific examples referred to in this disclosure, vector embeddings have dimensions of [1, 768].

The embedding by the second embedding layer 108-2 of the second operand “t0” proceeds in exactly the same way as for “a7”, except for the fact that the projection matrix 208-2 is different from the first projection matrix 208-1. Once the word embedding vector 109-2 has been derived for “t0”, it is combined (following projection, which is described in more detail below) with the embedding 109-1 calculated for “a7”.

The embedding by the third embedding layer 108-3, in this case for the number −2007, works differently from the first two embedding layers because it is processing a number rather than a register. In a first respect, additional pre-processing steps are required to convert the value into a string of characters that can be tokenised. Thus, as a first step, numbers and memory locations are converted into a hexadecimal 2's complement string of characters. 2's complement (or binary encoding) is used so that the number can be converted to fixed-digit representation. In this case, −2007 is converted into the string “FFFFF829”. 2's complement is used in this example, though any other binary encoding could equivalently be used.

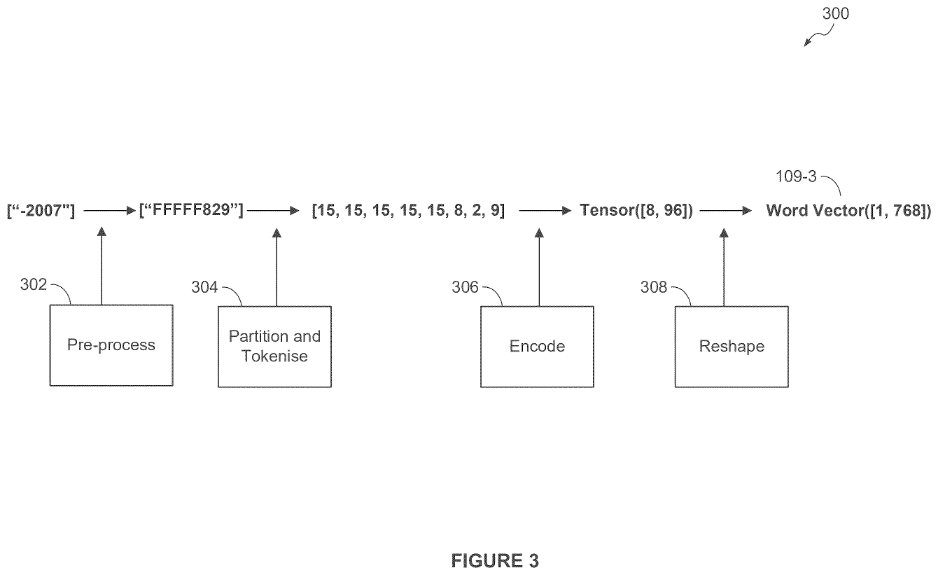

Thus, any 32-bit number can be converted into a fixed number (i.e., eight) of hexadecimal digits. This string is then encoded by the number embedder 202, whose vocabulary comprises the 16 available hexadecimal digits, plus the 1<UNK> control character (thus, a total vocabulary of 17 tokens). A specific example of how the hexadecimal string can be embedded is described below, with respect to FIG. 3. As with the register tokens (a7 and t0), the embedding layer 108-3 applied to the number also comprises a register embedder 200. The register embedder 200 does not recognise the hexadecimal string of characters, and so returns and embeds the <UNK> token. This embedded <UNK> token is then combined with the number vector 206 that is output by the number embedder to form a word vector 109-3 representing the number −2007.

Three embedding layers (i.e., 108-1, 108-2, 108-3) are shown in FIG. 2, though it should be appreciated that this is merely an example. The instruction 106 shown in FIG. 2 happens to have three operands, but as mentioned elsewhere the number of operands in the instruction may be zero, one, or more than one. Consequently, the number of embedding layers may be instruction may be zero, one, or more than one in examples. In RISC-V ASM, the greatest number of operands is likely to be four. However, in principle, the number of operands, and therefore the number of embedding layers, can be any plurality. Thus, the tokeniser is not limited, in principle, to any given number of embedding layers.

Once the word vectors 109-1, 109-2, 109-3, have been obtained for each of the operands, they are combined. In order for the resulting embedding to be interpretable/processable without information loss, the combination of the intermediate embeddings 109-1, 109-2, 109-3 should preserve the identity of the operands. The scheme described above with reference to FIG. 2 has been demonstrated experimentally to be fully reversible (that is, the original instruction can always be uniquely and correctly reconstructed from its embedding during processing and decoding), which the inventors have empirically established is due to the embedding vectors after projection being orthogonal (or approximately orthogonal). Therefore, a particularly advantageous possible feature of the present tokeniser is the use of an explicitly hierarchical encoding of the fields of an instruction, in which high-dimensional tensors are used to ‘layer’ fields through simple linear addition. A similar technique for preserving the identity of operands through an addition, using the near-orthogonality of high-dimensional embeddings is a technique known from hyperdimensional computing. In this context, the term ‘hyperdimensional’ simply means very high-dimensional, e.g., having more than say 50 or 100 dimensions. Once projected and combined, the combined embedding data can be recovered when decoding through a linear projection. In other words, the property of (near) orthogonality of the projection matrices 208 has been found to advantageously provide the preservation of information in the encodings, once summed together to obtain the final embedding 112. The preservation of information in turn allows reversibility of the encoding such that the original instruction can always be uniquely and correctly reconstructed.

Generally, the projection of the intermediate embeddings comprises applying an affine (i.e., linear) transformation to each of the operand embeddings, wherein each linear transformation is different and may be mutually orthogonal or mutually near-orthogonal (i.e., all possible pairs of tensors defining the transformation are orthogonal with respect to one another). The concept of ‘near-orthogonal’ in this context means that the effect is the same as if the vectors were strictly orthogonal. For example, for a 50-dimensional vector there exist exactly 50 (strictly) mutually orthogonal vectors belonging to strictly different basis sets. However, if near-orthogonality is allowed, there are many more (e.g., by an order of magnitude) pairs of ‘near-orthogonal’ vectors of dimension 50. The effect of near-orthogonality is achieved if the information contained in projected and combined vectors is recoverable after the projection and combination.

In more detail, orthogonal encoding using hyperdimensional vectors/tensors exploits the fact that any given pair of randomly chosen hyperdimensional vectors is highly likely to be nearly orthogonal or orthogonal. Thus, in order to perform the projection for each of the intermediate word embeddings 109, a tensor having commensurate dimensions with the embeddings 109 is selected with random values. For example, for word embeddings 109 with a dimension of [1, 768], a matrix with dimension [768, 768] may be chosen with random values. The randomly selected tensors are then multiplied with the embeddings to obtain projected embeddings. Once projected, as indicated in FIG. 2, the projected embeddings are linearly combined (i.e., by addition). Since linear summation is always commutative and associative, the order in which the projected vectors are summed does not matter.

Once projected to a random basis using the hyperdimensional tensors, the summed projections are added to the original, top-level, embedding 110. The near-orthogonality ensures that information representing completely different aspects of the instruction can be condensed into a single embedding in a manner that is information-preserving and reversible. Thus, advantageously, the commutativity and associativity of linear summation is not a barrier to recovering the information, since the near-orthogonality of the projection matrices has empirically been found to advantageously provide the preservation of information in the encodings.

As a final step, the position of the instruction 106 in the sequence (i.e., the sequence of the context window 102) is also embedded into a vector 210 and added to the embedding that has so far been accumulated by the structure vector 110 and the projected word-embeddings. The position embedding 210 is thus used to indicate to the GPT where each instruction belongs relative to the others. The final result is the embedding 112 which is also indicated in FIG. 1. It is this final embedding 112 that is input to the GPT, together with the embeddings generated for all other instructions (S1 to Sn) in the context window 102.

It should now be appreciated how the present tokeniser is able to guarantee correctness of the instruction output without needing to explicitly generate a vocabulary containing every possible, unique, assembly instruction. This can be summarised with two aspects. Firstly, by virtue of the fact that a formal language is being modelled with sub-vocabularies that do (ideally) contain exhaustive sets of vocabulary, completeness of the synthetically constructed vocabulary can be guaranteed. The synthetic vocabulary is a bespoke enumeration of all possible values according to the ISA, such that the completeness of the synthetic vocabulary is enforced. This is in contrast to a statistical tokeniser which generates a vocabulary statistically from a corpus. For a given ISA and set of ISA extensions, there will be no surprising, i.e., unknown, op-codes/operators with the present tokeniser. Secondly, the sizes of the vocabularies that are explicitly generated are kept tractable (which thereby ensures that training and inference are efficient) by exploiting the hierarchical structure of the language and thus enabling groups of vocabularies. The flexibility is introduced to the tokeniser by introducing variable fields populated by sub-tokenisers, where each of which has its own (restricted) vocabulary (e.g., corresponding to a particular group of registers).

FIG. 3 shows a detailed schematic for an example method of tokenising 32-bit numbers. A typical approach to embedding numbers is to embed each digit (e.g. in base-10) separately, which may result in a variable-length encoding. However, an objective of the present tokeniser is to provide fixed-rate encoding, and so the output embedding of the numerical tokeniser 202 should be consistent with the output embedding of each register tokeniser 200 in order to allow the output embeddings to be combined. It would be possible to re-project each separately-embedded bit of a 32-bit value to form a vector of the correct dimensions, although this creates the inefficiency of needing to project every individual embedding to the proper dimension. Moreover, if digits are embedded separately, positional encoding will also need to be incorporated to each individually embedded digit before they can be combined. The inventors have therefore developed an advantageously efficient method of tokenising a value that is adaptable to various different bit widths, and further advantageously uses only a small vocabulary. Further, the method shown in FIG. 3 provides a fixed-digit number representation (i.e., a number that has a predetermined number of bits).

As described above, the first step is to pre-process the number to form a fixed-length hexadecimal 2's complement string of characters corresponding to its binary representation, in this case “FFFFF829”. This solves the immediate problem of providing a fixed-digit number representation. Following this, the string is partitioned 304 into several sub-strings that are then tokenised separately. In this example, each individual character is tokenised separately to generate eight embeddings, which are recombined to form a final word vector of the correct dimension. However, it is also possible to partition the string into larger sub-strings which may be of irregular size, e.g., 1, 2 or more characters. For example, sub-strings of two characters could be tokenised to generate four embeddings (which would require a vocabulary of 256 to account for all permutations of a pair of hexadecimal digits).

Returning to the present example, each character in the string of “FFFFF829” is individually tokenised and then separately embedded. As before, this involves determining an ID for the token. The ID for each character is explicitly shown in FIG. 3 as [15, 15, 15, 15, 15, 8 2, 9]. Next, each ID is embedded separately to form vectors of length 96, which may together be considered as a tensor of dimension [8, 96]. The order of the hexadecimal values in the string is preserved by encoding them in the fixed order of most significant bit to least significant bit. Subsequently, the [8, 96] tensor is reshaped 308 to form a word-embedding 109-3 with the dimensions equal to the other word-embeddings (109-1, 109-2), i.e., in this example [1, 768]. This may equivalently be considered as a concatenation of all 8 length-96 numeral embeddings into a single 768-element vector.

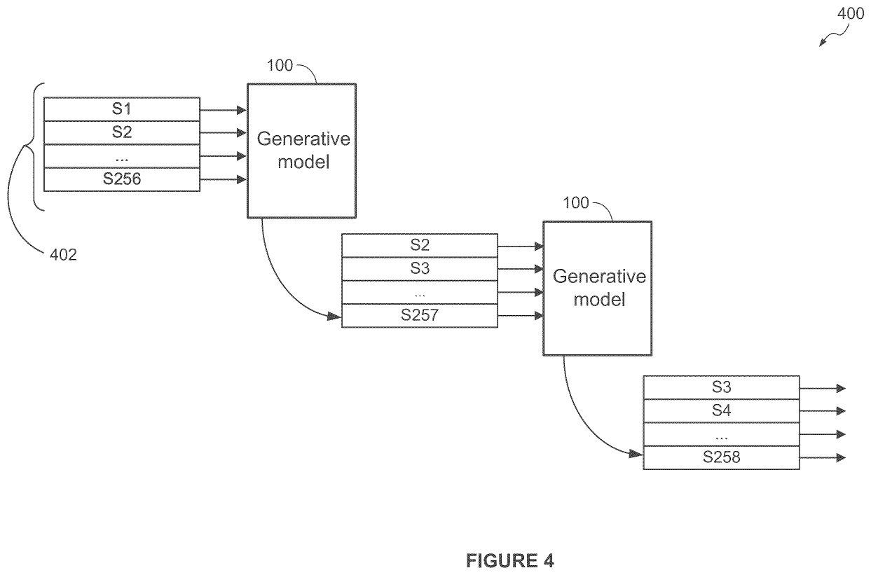

FIG. 4 illustrates how the generative model and tokeniser of the present disclosure may be deployed for the purpose of generating 400 stimulus code for CPU verification. As shown in FIG. 1, the initial input to the model may be a history of assembly instructions 102. This input is referred to as the context window 402. The size of the context window 402 can vary as the generative model is not, in principle, restricted to any particular size of context window. The proposed generative model is intended to be fixed-rate, meaning that the dimension of each unique embedding 112 (representing one instruction) is fixed. The size of this fixed width is called the “embedding width”, which in the examples contained in this disclosure is 768. The example of the generative model illustrated has a context window of 256, i.e., comprising 256 instructions.

The objective in the case of CPU verification is to generate good quality stimulus code representative of a training corpus, which may comprise real-use assembly code, e.g., compiled from production-grade C or C++ code. Moreover, the objective is to do this without the human bias that is inherent in test-engineer generated pseudo-random ASM sequences. After training, the language model can be used to generate novel ASM code by iteratively feeding a context window into the generative model 100 to generate a new instruction and feeding a new context window containing the newly generated instruction back into the generative model. In this example, new instruction S257 is generated. Thus, the context window fed into the next generation contains instruction S257 and excludes S1, since the context window in this case is limited to 256 instructions. The second iteration produces another new instruction, S258.

Since the context window represents the amount of input information the generative model can consider at any given time to generate a new instruction, a longer context window will provide more information to the model. Consequently, increasing the size of the context window enables the generative model to learn long-range dependencies that exist in the sequence of ASM instructions, e.g., where the choice of instruction may in fact depend on one or more instructions that came hundreds (or even thousands) of lines previously. Therefore, there is a balance to be struck with context window size, since the model will take longer to generate new instructions for larger context windows, and require computing resources with more bandwidth to run. However, an advantage of the present model is that, due to the fact that the tokeniser encodes an instruction's structure and its fields into a single embedding, a large amount of contextual information can be condensed into a relatively short context window. The inventors have found that a context window of 256 strikes a suitable balance between model efficiency and the ability to learn long-range dependencies in an instruction sequence. Moreover, a context window of 256 enables the generative model to be deployed on modest computing resources, i.e., consumer-grade GPUs that can be deployed in a typical workplace PC. However, preferably, larger context windows could be used (e.g., 4096) with hardware having higher bandwidth and memory.

Though not shown in FIG. 1 or FIG. 4, the structure of the GPT model underlying the generative model comprises used a decoder-only transformer architecture. This type of model is advantageous because it converges rapidly. This is advantageous in the context of CPU verification, where the inference of the generative model should be performed at ‘interactive rates’, since the GPT model can be both trained or fine-tuned and then deployed rapidly. The architecture deployed by the inventors in one example used 6 decoder blocks with an embedding width of 768. The model was trained using a training batch size of 32, and the model could be run on a single RTX® 2080 Ti GPU. In one training experiment performed by the inventors, each RISC-V test sequence contained up to 25000 instructions, where there were multiple versions of each constrained random test with different random seeds, for a total dataset of 1.34 million instructions. It will be understood that other datasets could equally be used. The memory-preload, helper branches and configurations were removed from the data to focus the model training solely on the payload. Furthermore, all register names were converted to ABI (Application Binary Interface) names to avoid multiple aliases being created for the same register.

FIG. 5 illustrates a method 500 of using the hierarchical structure of tokens defined by the present tokeniser to control the output of a language model in an advantageous way. The output of the method illustrated in FIG. 5 is a structure ID 512 representing a structure of a new segment/instruction. A benefit of the tokenisation scheme is that whole ASM instructions are embedded, and output, by the model. Further, the structure of each instruction is explicitly encoded within each embedding, which confers the ability to explicitly control the structure and content of individual fields within the output of the instruction. Exercising this type of control is not usually possible, because typical generative models use a fragmentary type of tokenisation (e.g., BPE), and so each output of a typical language model is a word fragment that is devoid of any internal structure.

FIG. 5 shows an input sequence of instructions, i.e., the context window 402, being fed into the GPT model 114. The initial output of a GPT is a vector embedding 116 having the same dimension as each token embedding generated by the tokeniser. In this example, the embedding width of the GPT is 768, and so the output vector embedding 116 has dimensions of 768 In order to generate the next instruction, a new token is predicted based on the output of the output vector embedding 116. The predicted token is based on the tokeniser vocabulary, which in the case of the top-level structural tokeniser 107 represents all possible category combinations and permutations for a given instruction. However, a new token cannot be sampled directly from the output vector embedding 116, and so this embedding 116 is converted into a probability distribution over the set of possible tokens. In other words, the output embedding 116 is converted into a vector of floating point values representing a probability distribution over the token vocabulary, whose dimension N is the size of the vocabulary. The values of the probability distribution output 508 are called ‘probits’.

To perform this conversion, a matrix multiplication 502 is applied to the output embedding vector 116. This conversion matrix is called an LLM ‘head’. The head has dimensions [768, N], where 768 is the embedding width only in this example, and N represents the size of the tokeniser vocabulary (i.e., of the structural tokeniser 107). The output logits 503 have dimensions of [1, N] for a single token. In other words, the structural head transforms the 768-element vector by a linear mapping to an N-element vector of structure logits, where N is the number of items in the structure vocabulary. The values of each logits (shown on the Y-axis) area indicative of a likelihood, however, the logit values are not normalised and so do not represent a probability in the mathematical sense. The logits 503 (once normalised) are used to classify the options for selecting the next output, and so the layer that performs the conversion resulting in the logits may be called the classification head.

The logits represent the predicted output of the model (i.e., predicted tokens representing an instruction). However, logits are unnormalized and do not define a probability. Thus, the logits are normalised by a Softmax function, applied at 506, which converts the logits into a probability distribution. The probabilistic outputs are called ‘probits’ 508, and they have the same dimensionality as the logits, i.e., [1, N]. In addition to normalising the logits, the Softmax function can effectively alters the entropy of the probability distribution. The Softmax function is defined as follows:

$${σ ( z )}_{i} = \frac{{e}^{β {z}_{i}}}{{\sum }_{j = 1}^{K} {e}^{{βz}_{j}}}$$

where β constant representing the statistical ‘temperature’ that is set to either increase or decrease the entropy of the output. Altering the entropy can be advantageous in order to yield either more conservative output, or a more speculative output. For example, it may be desired to output a more conservative instruction if the objective is to produce more predictable outputs that do not diverge in unexpected ways. The conservative approach might be useful to generate a set of stimulus code that exhaustively tests a specific region of the architectural state space, which would be useful for achieving high coverage of a desired region. On the other hand, it may be desirable to increase the entropy, and therefore the unpredictability, of the output. This inherently removes more human bias from the output when continuing a human-engineered seed sequence, since the predictability of the output is reduced. Producing an unpredictable, or a more ‘creative’, sequence of output instructions may be useful to explore the architectural state space of a CPU design as widely as possible. This is especially helpful, since it is impossible for a human to consider the entire state space of a given architecture. Increasing the entropy of the output (whilst still allowing manual control over certain outputs via the ‘masking’ described in FIG. 5) also allows a sequence to be generated that is abstracted away from a human imagination and understanding of the architecture design.

FIG. 5 illustrates the probit 508 as a discrete probability distribution. The illustration is not to scale, since the vocabulary N (along the X-axis) depicted is much smaller than for a practical example. The Y-axis represents the probability. Thus, each probit's value represents the probability that the corresponding token will appear next in a continuation of the input sequence 402, where each probit defines a token representing the structure of an ASM instruction.

Because each logit/probit represents a structure of an instruction, rather than an instruction in itself, it is possible to exercise control over which classes of structures are enabled in the output. In other words, it is possible to bias (condition) certain outputs to either increase or reduce the probability of particular word-categories. This biasing (conditioning) can be performed in a targeted manner since it is explicitly known which probits correspond to which token structures. Advantageously, the biasing conferred by the described model makes it possible to exercise precise control over which output structures to bias. Further, the extent to which certain outputs can be biased is unlimited.

One particularly useful instance of biasing probit outputs is to exclude certain categories altogether. This can be done by setting their probabilities to zero, such that they cannot be selected. The step of excluding certain categories altogether is referred to as ‘masking’ 504. The operation that puts the masking into effect is performed on the logits themselves, rather than the probits, as shown by the ‘mask logits’ 504 step in FIG. 5. Specifically, specific logit values are flattened such that, once the Softmax 506 is applied to the masked logits 505, the probits 508 correctly represent a probability distribution that accounts for the logits/probits whose values are zero. This ensures that the probability distribution is correctly normalised, i.e., that the output of the Softmax is a well-formed probability distribution and sums to 1. As can be seen in the equation above, the Softmax function, which outputs the probit distribution, raises logit values to an exponent. Thus, in this implementation, the values of the logits are set to (or notionally represented in the computer as) negative infinity, i.e., ‘−INF’. Since the exponent of negative infinity is deemed to be zero, the result of applying the Softmax function to logit values of ‘−INF’ is probit values equal to zero. In other words, a logit value of −INF corresponds to a probit value having zero probability.

There are many reasons why masking is performed. In the case of the high-level tokeniser, it may be desirable to exclude a particular register category from the output of the next instruction, e.g., registers in the “FP Saved” category. In order to exclude registers in this category, all probits defining tokens which contain that category can have their probability set to zero. This is illustrated in FIG. 5, in which a set of ‘masked probits’ 508 contains a subset of probits whose probabilities have been set to zero. The generative model 100 then samples 510 from the masked probits 508, so that the set of masked word-categories (e.g., all registers in the “FP Saved” category) cannot be chosen. Once sampled 510, the structure ID 512 of the new output segment is derived. It will be understood that the masking of logits for the high-level structure tokeniser shown in FIG. 5 is optional, as indicated by the dashed lines around the ‘mask logits’ step 504 and the ‘masked logits’ 505 object. Thus, in some examples, the Softmax 506 function is applied directly to the logits 503, rather than the masked logits 505.

It will be understood that the steps shown in FIG. 5 relate only to sampling tokens from the high-level tokeniser whose vocabulary represents possible structures of output segments. Thus, the resulting structure ID contains at least one placeholder indicating a particular word-category, e.g., a category of registers. For example, the result of sampling 510 the masked probits 508 may yield the following RISC-V ASM instruction structure ID 512: “li <args> <num>”, where <args> is a placeholder that represents a particular register category and <num> represents a 32-bit number. From this output structure, the actual values of the fields of the instruction may then be derived to obtain a complete instruction 118, as illustrated by FIG. 6.

The structure of the generative model is designed to mirror the structure of the tokenisers shown in FIG. 2. Specifically, the generative model is configured to generate separate probability distributions (i.e., probit outputs) for the instruction's top-level structure (as shown in FIG. 5), the registers (as tokenised by the register embedder 200), and the numerical fields (as tokenised by the number embedder 202). Thus, once the top-level structure has been derived (as in FIG. 5), this is used to selectively sample from the probability distributions produced for the register and numerical fields. Each of these probability distributions are also generated using respective ‘head’ tensors that map an embedding vector to a set of probits representing the desired vocabulary. For example, the ‘head’ for the register fields will produce a set of probits having a dimension equal to the number of possible registers. As a result of sampling from each of the top-level probability distributions, register probability distributions, and if necessary the numerical probability distributions (steps not shown in FIG. 5), the complete form of the newly-generated instruction 118 will be derived. It should also be appreciated that the ‘masking’ of certain output categories or types is equally applicable to the register and numerical probability distributions.

FIG. 6 shows how a complete instruction may be decoded 600 from the raw data of the output vector embedding 166 produced by a language model. FIG. 5 indicates how a token representing the high-level structure of an ASM instruction is derived using a Softmax function and subsequent sampling stage. However, since the token representing the structure contains placeholders identifying the operands (e.g., placeholders such as the <args>, <tmps>, and <num> placeholders shown in FIG. 2) the identities of the operands themselves still need to be determined by sampling.

FIG. 6 contains a brief illustration of the process of decoding the structure ID 512 of a new instruction, which is illustrated in detail in FIG. 5. The structure ID 512, as described above, contains placeholders for the operands and not the operands themselves. Therefore, the identity of the operands is determined by analogous steps to those shown in FIG. 5. However, to decode the complete instruction, the placeholders are used to ensure that the correct operand(s) is/are selected. Thus, a masking process similar to that shown in FIG. 5, and described above, is always used during the full decoding 600 in order to select each operand from the correct category.

The starting point for the decoding is the output vector embedding 116, which may have dimensions [1, 768] as in the examples above. This is merely the length of the embedding 116, and is not directly related to the size of the vocabulary. The structural head matrix 502, the “Softmax and Sample 506, 510, represent the steps shown in FIG. 5. The structure ID that results from this represents placeholders, optionally containing one or more actual token values, e.g., such as “li <rg1> <num>”, where “li” is an operator and <rg1> and <num> are placeholders. Optionally, a mask may be applied before the structure-level Softmax 506 operation, according to the process described with reference to FIG. 5. Merely for illustrative clarity and brevity, the structural mask is not shown in FIG. 6.

As with decoding the structural ID, the embedding for each operand is decoded by a respective ‘operand head’. As with the structural head, each operand head is a matrix. In one sense, this mirrors the structure of the embedding layers shown in FIG. 2, in which each operand is encoded by a separate layer. Each operand head (606-1, 606-2, 606-3) is configured to either decode numbers or registers. Therefore, prior to applying the head matrix, each operand head is instructed whether to select the ‘number’ head or the ‘register’ head, as appropriate. Thus, it should be appreciated that each operand head (606-1, 606-2, 606-3) actually represents two heads, only one of which is selected.

It will therefore be appreciated that the operand head needs to be instructed what type of operand it is decoding. Thus, the operand needs prior knowledge of the structure ID 512 which was yielded by sampling the structure distribution. Thus, each operand head is fed this prior information, indicated by the ‘detect operand’ (604-1, 604-2, 604-3) units shown in FIG. 5. The function of the ‘detect operand’ is to select the appropriate decode head (i.e. the decode head corresponding to registers or numbers). Additionally, the function of ‘detect operand’ is to select any active mask for the operand. For example, if the structure ID is “li <args> <num>”, then the <args> placeholder is fed into ‘detect operand 1’ 604-1. ‘Detect operand 1’ 604-1 then instructs the relevant operand head (606-1) to decode using the register head, and selects the relevant mask (corresponding to placeholder <args>) to apply. As indicated in FIG. 5, the mask is applied (608-1, 608-2, 608-3) at a later step.

The vector that is actually decoded by each operand head is derived directly from the output vector embedding, i.e., the same embedding 116 used to derive the structure. In order to obtain the correct embedding for each operand, the output vector embedding 116 is projected using different and unique projectors, one projector (602-1, 602-2, 602-3) for each operand. These projectors (602-1, 602-2, 602-3) correspond to, but are nonetheless different from, the projections used during the encoding shown in FIG. 2. Each projection defines the position of the operand: so, the “operand projection 1” 602-1 is designed to decode an operand to appear in the first position in the output instruction, “operand projection 2” 602-2 decodes an operand to appear in the second position in the output instruction, and so on. As shown in FIG. 6, the output for each operand projection is fed into the operand head corresponding to that position, i.e., the ‘operand projection 1’ 602-1 is output to the first operand head 606-1, ‘operand projection 2’ 602-2 is output to the second operand head 606-2, and so it should be appreciated that FIG. 6 shows that the final instruction contains 3 operands, but this is merely an example. As described earlier, an instruction may contain zero, one, or a plurality of operands (in addition to an operator).

Accordingly, each operand head (606-1, 606-2, 606-3) receives i) an indication of the type/category of operand, and ii) a projected version of the output vector embedding (which is projected in accordance with the relevant operand position). With the information, the operand head is able to decode the vector embedding to output logits corresponding to a set of possible output operands. In this example, as with the encoding stages shown in FIG. 2, a single register head decoder covers all register categories. However, other design choices are possible. For example, it is also possible to have a separate word tokeniser, vocabulary and decoder for each register category. This approach may have some advantages, although it is less practical in the sense that it would requires a larger and more complex computational graph.

In this example, the output of each operand head is a set of logits whose vocabulary represents all possible registers (or numbers). However, each operand had already been selected to correspond to a particular category, i.e., by the placeholder indicated in the structure ID. Thus, for the logits output by each operand head, the registers that do not correspond to the placeholder indicated in the structure ID 512 should be masked so that they are not selected. For example, for the structure ID “li <args> <num>”, the placeholder <args> indicates that the first operand should belong to the <args> category. Thus, registers belonging to all other categories (e.g., those listed in Tables 1 and 2) should be masked. The masking is applied at step 608(-1, -2, -3). The relevant mask(s) is obtained from the ‘detect operand’ 604(-1, -2, 3) stage. As described in respect of FIG. 5, the relevant logits may be masked by setting their values equal to ‘−INF’, such that when the Softmax is applied to turn the logits into probits, their corresponding probits values become zero (meaning the probability of those probits being sampled is zero).

After the masking is applied 608(-1, -2, -3) to exclude the relevant operand categories for each operand, a Softmax function 610(-1, -2, 3) is applied (described above with reference to FIG. 5) to obtain a set of probits for each operand. All probits corresponding to register categories other than the register category indicted in the structure ID should be set to zero. For example, for operand 1, all register identities in the register vocabulary that do not belong in the <args> category should be set to zero in the probits produced by the first Softmax function 610-1. This means that the probits for each operand (yielded by the Softmax operation 610(-1, -2, -3)) represents probability distribution over the sub-vocabulary of registers belonging to the relevant category (e.g., registers in the <args> category for operand 1).

Each set of probits is then sampled at step 612(-1, -2, -3), which yields a particular operand ID. These operand IDs are substituted into the already-decoded structure, which may be identified in the structure ID. Consequently, a complete instruction is derived from the output vector embedding 116 by combining the already-derived structure ID 512 with each newly derived operand ID 614(-1, -2, -3) to obtain a new instruction 118.

Two additional features are shown in FIG. 6, which may optionally be used to fine-tune the sampling of the probits. Firstly, as described above in reference to FIG. 5, a parameter of the Softmax function is the entropic temperature, which scales the output according to the temperature value. Thus, the temperature of the Softmax function can be used to control 616 the entropy of the probit distribution. The same applies to the Softmax that is applied to the structural head, though this is not shown in FIG. 6. Secondly, the discrete probit distribution can be further filtered using a ‘top-k’ 618 value, which sets all but the k most likely outputs to zero. This ‘top-k’ selection 618 is often used to control sampling in the context of language modelling. Again, the same applies to the probits for the structural ID in FIG. 5, though this is not indicated.

The table below provides an example output of the generative model. The table compares the ‘ground truth’ values representing the true continuation of the ASM sequence with a ‘conservative’ output generated by the model (i.e., by applying a Softmax with low entropy) and a ‘creative’ output generated by the model (i.e., by applying a Softmax with high entropy and thus increased unpredictability). For this experiment, a context window of 256 was used, and the ‘seed’ instructions used as an initial input the model contained 256 ‘ground truth’ instructions. Only the last five instructions (in bold) of the ground truth input is shown in the table below. As such, the instructions generated by the model begin in the sixth line, in the second and third columns of the table. The ASM instructions in this example are based on the RISC-V ISA.

| | Model Prediction | Model Prediction |
|---|---|---|
| Ground Truth | (Conservative) | (Creative) |
| mulhsu tp, t1, a2 | mulhsu tp, t1, a2 | mulhsu tp, t1, a2 |
| nop | nop | nop |
| mulh s10, t5, s9 | mulh s10, t5, s9 | mulh s10, t5, s9 |
| li a1, 0x80000000 | li a1, 0x80000000 | li a1, 0x80000000 |
| li s8, 0xffffffff | li s8, 0xffffffff | li s8, 0xffffffff |
| li s5, 0x05dbbecf | li s10, 0x8000000f | li s5, 0x8000000f |
| li s0, 0xb36e2cd3 | li s10, 0x8000000f | li a0, 0x8000000f |
| li a2, 0xbf184ce0 | li s6, 0x600000ff | li tp, 0xffffffff |
| li t0, 0x00000000 | li tp, 0xf00000ff | li a6, 0x8000000f |
| li s2, 0x503aa2f1 | li s5, 0x000000ff | mulh ra, ra, t3 |
| li t4, 0xffffffff | li s3, 0xffffffff | add s3, a3, gp |
| li a6, 0x80000000 | li t1, 0x800000ff | divu t3, a2, t2 |
| li s1, 0x1aa27319 | li t0, 0x000000ff | sltu tp, sp, a5 |
| mulhsu s5, s5, s2 | lui s5, 1047295 | add s4, t2, t5 |
| divu s8, t4, s2 | add a5, a4, s10 | and t4, s0, t5 |
| remu s0, s2, a6 | mulhsu s11, s8, a5 | sub a2, a2, tp |
| nop | divu s9, t2, t0 | lb s0, 550398 (gp) |
| sub to, s2, s1 | divu s9, t2, t1 | mul s5, s10, s0 |
| lui s1, 595995 | divu gp, s1, t1 | rem ra, a3, t5 |
| add s1, t4, s0 | nop | mulhsu s10, tp, t2 |
| auipc s0, 1025613 | lui a4, 40968 | and t0, s10, ra |
| rem t0, t4, s2 | bge gp, sp, <b_target> | ori gp, s4, 0 |
| mulhsu s5, s0, a2 | divu t0, sp, s7 | sll gp, s10, s1 |
| divu a6, s5, a2 | mul a5, a4, s10 | divu t3, t2, s10 |
| add s8, s8, s8 | mulhu t1, gp, a2 | divu gp, a4, a2 |
| mul s1, s5, t4 | srl a4, s10, s7 | sltiu a5, tp, 910 |
| div s8, s2, a6 | addi s7, sp, −312 | or ra, s11, a2 |
| mulhsu t4, s8, s5 | add a6, t4, s3 | mul s10, zero, sp |
| add t4, s1, a1 | sll a1, gp, a5 | xor a0, s0, a0 |
| mulhsu s2, a6, s5 | addi a3, sp, −3792 | addi a7, s6, 1018 |
| remu al, s1, s1 | remu a4, s10, ra | lb ra, 80656 (sp) |
| mul s2, s8, s5 | mulh sp, s7, s0 | srli gp, s4, 0 |
| mul s2, s2, s8 | add t1, t1, a2 | remu a7, ra, a5 |
| divu s5, t4, a2 | auipc s10, 102408 | addi a3, ra, 0 |
| mulhsu a6, s0, t4 | sltu tp, a4, s3 | div a5, s8, t1 |
| li sp, 0xffffffff | divu s6, a4, s9 | ori t5, tp, 244 |
| li t1, 0xb52d508f | lui s10, 5112 | sltu zero, sp, sp |

It can be observed that the model generally understands the types of instructions that are most likely to appear in the context of previous instructions. Moreover, the model is capable of continuing long-range patterns that exist in the ground truth sequence, such as a sequence of memory reads. The ability to determine long-range dependencies in the ground truth data would be yet further improved by increasing the context window beyond 256. This can be readily implemented by the present model and tokeniser, since the algorithm itself places no effective limit on the size of the context window. The main constraint is the memory and bandwidth of the hardware on which the model is implemented, and so the context window could be increased immediately if implemented on, e.g., a GPU having more RAM, or a cluster of GPUs.

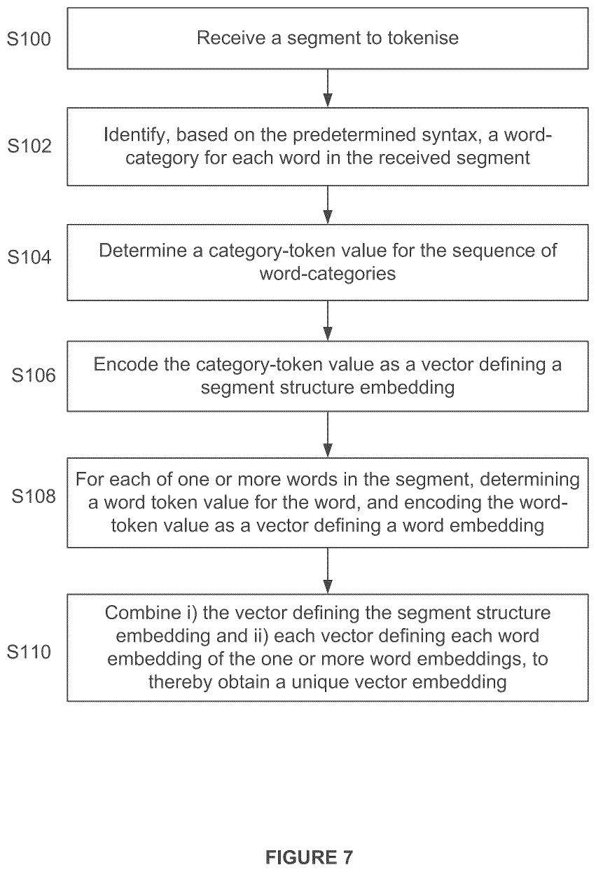

FIG. 7 shows a flowchart illustrating the general method of tokenising a structured language for use in a generative language model. As mentioned, the structured language need not be based on a RISC ISA, or comprise assembly code, or even relate to a programming language. Generally, the present tokeniser may be applicable to encoding embeddings for any structured language that is formed of segments, wherein each segment comprises a plurality of words and is formed using a predetermined syntax. For example, short phrases of the English language, provided that they contain a limited number of verbs, objects, and subjects, in a stricter syntax than is used colloquially, could be suitable for tokenisation by the present tokeniser and language model. Merely for explanatory clarity and brevity, the following flowchart is described with reference to previous examples that use ASM language based on the RISC-V ISA.

Step S100 involves receiving a segment to tokenise. This segment may be a single ASM instruction, for example the instruction 106 shown in FIG. 2: “sltiu a7, t0, −2007”.

Step S102 comprises identifying, based on the predetermined syntax, a word-category for each word in the received segment. The result is therefore a sequence of word-categories. In the case of RISC-V assembly, the syntax is known to be formed of: an operator, and zero, one or more operands (usually three or four, but possibly more). The operands comprise up to three registers and/or a number and/or memory address. The order is also known, i.e., the operator is the first word/field in the instruction. As explained above, word-categories are determined for registers in order to reduce the vocabulary of the top-level tokeniser 107. Thus, for register “a7” and “t0” the appropriate word-category is found. This is illustrated in FIG. 2 as “<args> and “<tmps>”. The word-category for the number “−2007” is simply the mask “<num>”.

In the specific example deployed by the inventors in the case of RISC-V assembly, the number of possible operators in the ISA was deemed to be small enough that further categorisation was not necessary. Consequently, for the operator “sltiu”, the word-category is the word “sltiu” itself. In some examples, all fields within the segment may be replaced with a word-category. In other examples, more than one field within the instruction may not be sub-categorised, and may simply be encoded using its actual value rather than using a placeholder representative of a word-category. It should be appreciated that there is a balance to be struck between efficiency and vocabulary size. In respect of the high-level tokeniser 107, the tokeniser vocabulary is defined by all different possible combinations and permutations of word-categories for an instruction. Categorising more fields/words in the segment therefore reduces the tokeniser vocabulary and thus increases efficiency. On the other hand, using the actual values of the fields, rather than using a placeholder representative of a word-category, inevitably increases the size of the vocabulary of the top-level tokeniser (since more combinations and permutations must be accounted for). This reduces efficiency, though a large vocabulary allows for more statistical information to be captured in the unique embedding.

Step 104 comprises determining a category-token value for the sequence of word-categories identified in step S102. Specifically, this step may involve determining an ID for the sequence of word-categories, where the ID is represented by an integer that uniquely identifies the specific combinations of word-categories in the sequence. In more detail, the token and/or ID may be identified from a vocabulary containing a mapping of all possible combinations and permutations of word-categories to IDs.

Step S106 comprises encoding the category-token value as a vector defining a segment structure embedding. This step is illustrated in FIG. 2 as determining the “structure vector” 110. Consequently, the structure of a whole segment is encoded within a single embedding 110 following step S106. In some implementations, steps S104 and S106 may be combined, e.g. a vocabulary may map word-categories directly to embedding vectors.

Step 108 comprises, for each of one or more words in the segment, determining a word token value for the word, and encoding the word-token value as a vector defining a word embedding. In other words, an ID value is determined for one or more words in the segment, and a separate embedding is determined for each of these words.

In practice, the one or more words that are encoded as a word embedding in this step are the words in the segment that were replaced by categories in step S102. It should therefore be appreciated that not all of the words within the segment may be embedded individually using a word-token value. For example, in the case of FIG. 2 where the segment is “sltiu a7, t0, −2007”, the first word, sltiu, is already encoded using its actual value in the high-level structural embedding 110. Consequently, it would be redundant to generate another embedding for this word. Thus, referring to the FIG. 2 example, word-token values are derived only for the words “a7”, “t0”, and “−2007”, which are subsequently embedded as individual word embeddings. For the avoidance of doubt, in the context of a segment a ‘word’ is an individual field within the instruction, e.g., a number, or a string of characters, or even a single character.

Step S110 comprises combining i) the vector 110 defining the segment structure embedding and ii) each vector 109-1, 109-2, 109-3 defining each word embedding of one or more word embeddings, to thereby obtain a unique vector embedding. The unique embedding uniquely defines the segment and is arranged to be input into a language model.

Step 108 comprises, for each of one or more words in the segment, determining a word token value for the word, and encoding the word-token value as a vector defining a word embedding.

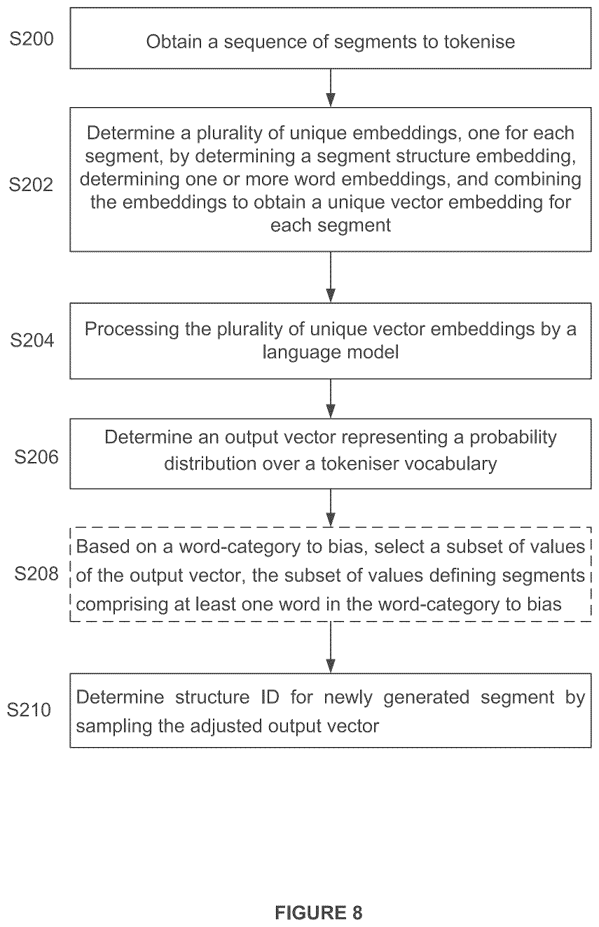

FIG. 8 shows a flowchart illustrating a method of using the presently disclosed tokenisation method as part of a language model to bias (condition) the output in a targeted manner. As described above, an advantage that is uniquely conferred by the hierarchical tokenisation method is that the structure and content of the output can be controlled precisely. This is because the embedding produced by the tokeniser multiplexes a structure of segments that are tokenised within the embeddings together with the actual content of the segments.

Step S200 involves receiving a sequence of segments to tokenise. For example, this could be the context window 402 comprising a sequence of ASM instructions.

Step S202 comprises determining a plurality of unique embeddings, one for each segment, by determining a segment structure embedding, determining one or more word embeddings, and combining the embeddings to obtain a unique vector embedding for each segment. More specific examples of performing this step are described in respect of FIG. 7 by steps S102 to S110. A yet further detailed example is shown in respect of FIG. 2.

Step S204 comprises processing the plurality of unique vector embeddings by a language model. This is performed by the language model, e.g., model 114 shown in FIG. 5. As a result of the processing, at step S206, an output vector is determined representing a probability distribution over a tokeniser vocabulary. Thus, steps S204 and S206 may be performed by the language model. The output vector in this case represents either the logits 503 or probits 505 shown in FIG. 5. As described in FIG. 5, step S206 of determining the output vector may include adjusting the distribution of the orbits 508 by varying the entropy of the Softmax output, e.g., as controlled by the temperature parameter.

Step S208 comprises, based on a word-category to bias, selecting a subset of values of the output vector, the subset of values defining segments comprising at least one word in the word-category to bias. In other words, in dependence on a word-category to bias, selecting a subset of values of the output vector, wherein the subset of values defines segments comprising at least one word in the word-category to bias. As described above, this might involve determining that a particular word is to be biased in the output, for example, excluded from being generated. The word to be biased may be determined by some other function of the language model, or may be manually set as a restriction by a user. FIG. 5 indicates an example of a subset of values to be ‘masked’ 506 from the output vector 504. It should also be appreciated that this same method is applied within each word category/placeholder, e.g., as described with reference to FIG. 6.

Step S210 comprises determining a structure ID for the newly generated segment by sampling the adjusted output vector. For example, if the subset of values represented segments comprising a register in the category of ‘FP Saved’, and the probability of that subset of values were set to zero, this would guarantee that the newly generated output produced by the language model, based on sampling the adjusted output vector, would not contain any registers in the ‘FP Saved’. Advantageously, because all probit values correspond to segments that comprise valid pre-determined syntax (e.g., in the case of RISC-V, legal instructions) it is still guaranteed that whatever token is sampled will contain valid syntax. Without the information of the pre-determined syntax being incorporated in the embeddings 112 this would not be possible. For example, using a fragmentary tokenisation like BPE, it would only be possible to restrict individual tokens for output, and there would be no guarantee that a collection of BPE tokens defining a segment or instruction would be legal.

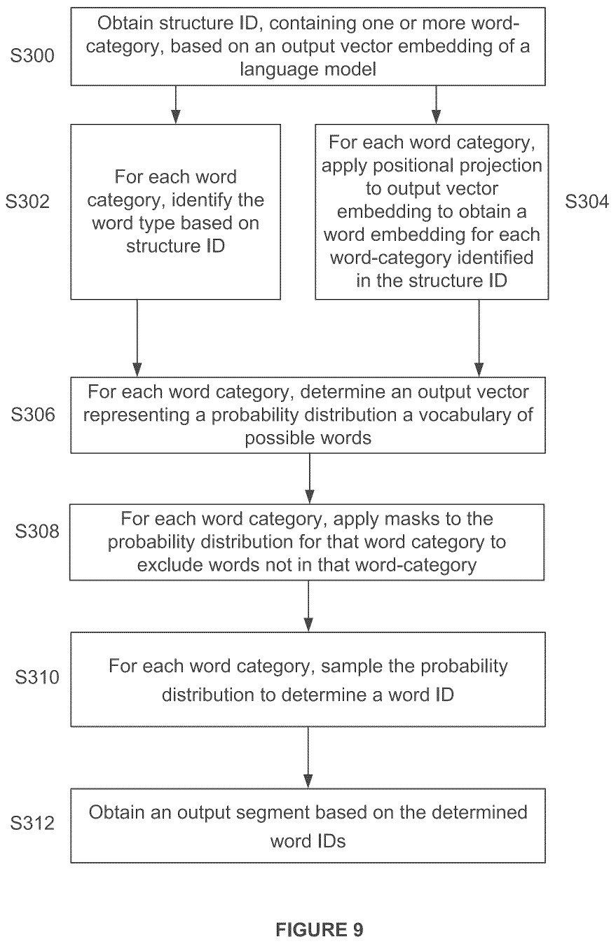

FIG. 9 shows a flowchart illustrating a method of decoding a complete instruction, e.g., in accordance with the schematic shown in FIG. 6.

Step S300 comprises obtaining a structure ID, containing one or more word-categories, based on an output vector embedding of a language model. Thus, this step relates to the steps illustrated in FIG. 5, e.g., where the output vector embedding 116 represents the output of a language model and the structure ID 512 represents the high-level structure token (including placeholders) representing the structure of the segment. The structure ID contains one or more word-categories. Some of the fields in the structure ID may be actual words rather than categories, and thus the actual words do not need to be further encoded.

Step S302 involves, for each word category, identify the word type based on structure ID. In other words, this step involves, for each word category identified by the structure ID of the segment that still needs decoding (i.e., for each word represented by a placeholder), identifying the word type. In the example of ASM instructions such as outlined in respect of FIG. 6, this might involve determining that an operand type represented by a placeholder is a register or a number.

Step S304 occurs separately to step S302, i.e., step S302 and S304 do not depend on one another. Steps S302 and S304 may therefore be carried out concurrently. Step S304 involves, for each word category, applying a (unique) positional projection to the output vector embedding in order to obtain a word embedding for each word-category identified in the structure ID. This corresponds to applying the projections (602-1, 602-2, 602-3) as outlined in FIG. 6.

Step S306 involves, for each word category, determining an output vector representing a probability distribution over a vocabulary of possible words. This represents, in some examples, the steps of using a matrix ‘head’ to decode the (projected) output vector embeddings derived for each word category in order to obtain a set of logits, where the logits correspond to the vocabulary of possible words.

Step S308 involves, for each word category, applying masks to the probability distribution for that word category to exclude words not in that word-category. As outlined in FIG. 6, the logits are transformed into probits first my masking any logits which corresponds to words (operands) that do not belong in the relevant word category, and then applying a Softmax in order to transform the logits into a well-formed probability distribution of probits. Thus, step S308 corresponds in one example to this step of masking and applying a Softmax function. It should be noted that, for decoding a word/operand that is a number, step S308 is not necessary.

Step S310 involves, for each word category, sampling the probability distribution to determine a word ID. In other words, and referring to the example outlined in FIG. 6, for each word category identified in the structure ID for which a word needs to be sampled, the probits derived for that word category are sampled in order to determine a likely possible word within the indicated word category.

Step S312 finally involves obtain a completed output segment based on the word IDs determined in step S310, and using any words that were already identified in the structure ID. For example, the structure ID may have identified a specific operator for an ASM instruction, but used placeholders to indicate word categories for the one or more operands. This step corresponds to the illustration in FIG. 6 in which the structure ID 512 and the operand IDs 614 are combined to form the new instruction 118.

Building on the methods of tokenisation and segment generation in the present disclosure, it is possible to provide an interface with the generative model, controllable by an end user, for the purposes of controlling which types of segments to output based on some desired criteria. The interface may be a graphical user interface to yet further enhance the human-machine interaction involved in verification workflows. This would be particularly advantageous in the field of CPU verification. In such an example, the end user may be a verification engineer, and the interface may allow the verification engineer to create a workflow that would enable the engineer to determine a particular set of new sequences with which to test the operation of a CPU. For example, it may be desirable to deliberately choose dissimilar sequences for efficient coverage of the latent space. Alternatively, it may be desirable to identify similar sequences in order to thoroughly cover a specific area of latent spec, e.g., in order to trigger known bugs.

The advantage of using the presently-disclosed tokeniser for hardware verification and testing applications is described above, e.g., generating high quality stimulus. This involves generating randomised code (albeit possibly directed towards a certain region of the architectural state space). However, the presently disclosed tokeniser could also find application in other code-generation or code-optimisation scenarios. For example, the tokeniser could be deployed in an application designed to generate code for a particular task, i.e. GEMV, matrix multiplication, or convolution. The use of the tokeniser could, amongst other things, ensure the correctness assembly produced for such tasks. The tokeniser could also be used to generates instructions to minimise inference time in machine learning applications that require these functionalities.

It should be appreciated that, in general, the applications of the present tokeniser reach beyond its use in generating and outputting textual input for language models. In some implementations, the presently disclosed tokeniser could be applied to ‘transpilation’ problems. A portmanteau of transformation and compilation, transpilation is the process of converting source code from one programming language to another. Typically, transpilation is applied for high-level programming languages, but the presently disclosed tokeniser could find applications in translating one assembly language to another. One such example would be translating CISC (complex instruction set computer) into RISC, and vice versa. Another example would be MLIR (Multi-Level Intermediate Representation) into SPIR-V (Standard Portable Intermediate Representation), for example.

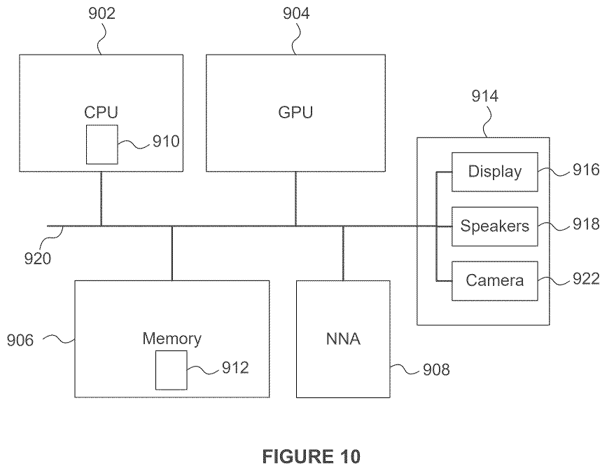

FIG. 10 shows a computer system in which processing systems described herein may be implemented. The computer system comprises a CPU 902, a GPU 904, a memory 906, a neural network accelerator (NNA) 908 and other devices 914, such as a display 916, speakers 918 and a camera 922. A processing block 910 is implemented on the CPU 902. In other examples, one or more of the depicted components may be omitted from the system, and/or the processing block 910 may be implemented on the GPU 904 or within the NNA 908. The components of the computer system can communicate with each other via a communications bus 920. A store 912 is implemented as part of the memory 906.

The tokenisation and generative models of FIGS. 1 to 6 are shown as comprising a number of functional blocks. This is schematic only and is not intended to define a strict division between different logic elements of such entities. Each functional block may be provided in any suitable manner. It is to be understood that intermediate values described herein as being formed by tokenisation and generative models need not be physically generated by the tokenisation or generative models at any point and may merely represent logical values which conveniently describe the processing performed by the tokenisation or generative models between its input and output.

The tokenisation and generative models described herein may be embodied in hardware on an integrated circuit. The tokenisation and generative models described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a tokenisation unit or generative model unit configured to perform any of the methods described herein, or to manufacture a tokenisation unit or generative model unit comprising any apparatus described herein. An integrated circuit definition dataset may be, for example, an integrated circuit description.

Therefore, there may be provided a method of manufacturing, at an integrated circuit manufacturing system, a tokenisation unit or generative model unit as described herein. Furthermore, there may be provided an integrated circuit definition dataset that, when processed in an integrated circuit manufacturing system, causes the method of manufacturing a tokenisation unit or generative model unit to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS® and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

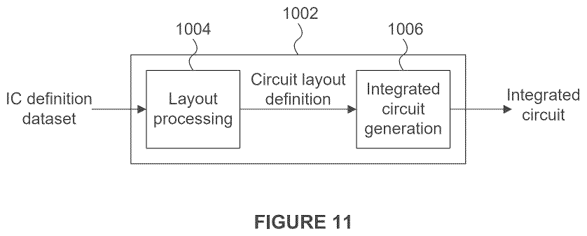

An example of processing an integrated circuit definition dataset at an integrated circuit manufacturing system so as to configure the system to manufacture a tokenisation unit or generative model unit will now be described with respect to FIG. 11.

FIG. 11 shows an example of an integrated circuit (IC) manufacturing system 1002 which is configured to manufacture a tokenisation unit or generative model unit as described in any of the examples herein. In particular, the IC manufacturing system 1002 comprises a layout processing system 1004 and an integrated circuit generation system 1006. The IC manufacturing system 1002 is configured to receive an IC definition dataset (e.g. defining a tokenisation unit or generative model unit as described in any of the examples herein), process the IC definition dataset, and generate an IC according to the IC definition dataset (e.g. which embodies a tokenisation unit or generative model unit as described in any of the examples herein). The processing of the IC definition dataset configures the IC manufacturing system 1002 to manufacture an integrated circuit embodying a tokenisation unit or generative model unit as described in any of the examples herein.

The layout processing system 1004 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 1004 has determined the circuit layout it may output a circuit layout definition to the IC generation system 1006. A circuit layout definition may be, for example, a circuit layout description.

The IC generation system 1006 generates an IC according to the circuit layout definition, as is known in the art. For example, the IC generation system 1006 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1006 can use to form a suitable mask for use in generating an IC.

The different processes performed by the IC manufacturing system 1002 may be implemented all in one location, e.g. by one party. Alternatively, the IC manufacturing system 1002 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a tokenisation unit or generative model unit without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 11 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 11, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

An aspect of the present disclosure may be understood with reference to the following clauses, which relate to a method of generating a new segment using the presently disclosed tokeniser and a suitable language model:
1. A method of generating a segment of a structured language using a language model, wherein each segment of the structured language comprises a plurality of words and is formed using a predetermined syntax, the method comprising:
   obtaining a sequence of segments of the structured language;
   tokenising each of the segments to generate a plurality of unique embeddings, each unique embedding representing one segment, wherein the tokenising comprises, for each segment:
      determining a segment structure embedding of the segment comprising identifying, based on the predetermined syntax, a word-category for each word in the received segment;
      determining one or more word embeddings for a respective one or more words in the segment;
      combining the segment structure embedding and the one or more word embeddings to obtain the unique vector embedding, which uniquely defines the segment;
   decoding, by the language model, the plurality of unique vector embeddings;
   in dependence on the decoding, determining, by the language model, an output vector representing a probability distribution over a tokeniser vocabulary, wherein the tokeniser vocabulary is defined by a number of different possible combinations and permutations of word-categories for a segment;
   determining a word-category to bias in a generated segment;
   in dependence on the word-category to bias, selecting a subset of values of the output vector, wherein the subset of values define segments comprising at least one word in the word-category to bias;
   obtaining an adjusted output vector by adjusting a probability value of each value in the subset of values;
   determining the generated segment by sampling the adjusted output vector.
2. The method of clause 1 wherein the word-category to bias represents a word-category to exclude, wherein obtaining the adjusted output vector comprises setting a probability value of each value in the subset of values to zero.
3. The method of clause 1 or 2, wherein determining the segment structure embedding of the segment further comprises:
   obtaining a sequence of word-categories based on the identifying a word-category for each word in the received segment;
   determining a category-token value for the sequence of word-categories; and
   encoding the category-token value as a vector defining the segment structure embedding.
4. The method of clause 3, wherein determining the plurality of word embeddings comprises, for each word in the segment:
   determining a word-token value for the word; and
   encoding the word-token value as a vector defining the word embedding.
5. The method of clause 4, wherein determining the unique vector embedding comprises combining i) the vector defining the segment structure embedding and ii) each vector defining each word embedding of the one or more word embeddings.
6. The method of clause 5, wherein a dimension of the vector defining the segment structure embedding, and a dimension of each vector defining each word embedding of the one or more word embeddings, is equal.
7. The method of clause 6, wherein each of i) the vector defining the segment structure embedding, and ii) each vector defining each word embedding, are substantially orthogonal, and wherein determining the unique vector embedding comprises linearly combining each of i) the vector defining the segment structure embedding, and ii) each vector defining each word embedding.
8. The method of clause 7, wherein determining the unique vector embedding comprises:
   applying a linear transformation to each of i) the vector defining the segment structure embedding, and ii) each vector defining each word embedding to obtain a plurality of transformed vectors, each linear transformation is different;
   linearly combining the plurality of transformed vectors to obtain the unique vector embedding.
9. The method of any preceding clauses, wherein each word in each segment has a word-type, wherein the word-type is one of: an operator, an operand, and a number, and wherein each word-type comprises one or more possible word-categories.
10. The method of clause 9, wherein the structured language is an assembly language for a CPU, and each segment is a single assembly instruction.
11. The method of clause 10, wherein the CPU uses a RISC microprocessor architecture, and wherein each segment is an assembly instruction for the RISC microprocessor architecture. In example implementations, the CPU is based on a RISC-V microprocessor architecture. In example implementations, an operand is a register, and the operand word-type may include a plurality of word-categories corresponding to a plurality of different register groups. The number may represent a value or a memory location, and so the number word-type may include word-categories of number category and memory locations category.
12. The method of clause 10 or 11, wherein the predetermined syntax used to form each segment is defined by a list of word-types in a predetermined order. In example implementations, the order for a RISC-V instruction is i) operator ii) operand, and iii) number, wherein the instruction comprises i) an operator, ii) zero, one or more operands, and iii) zero, one or more numbers.

Another aspect of the present disclosure may be understood with reference to the following clauses, which relate to a method of tokenising a structured language:
1. A method of tokenising a language segment for use in a language model, wherein the structured language is formed of segments, and wherein the language segment comprises a plurality of words, the method comprising:
   receiving a segment to tokenise;
   determining one of a plurality of word-embeddings by, for each word in the segment:
      determining a word-token value for the word; and
      encoding the word-token value as a vector defining a word embedding;
   determining a unique vector embedding defining the segment by combining each vector defining each word embedding of the plurality of word embeddings, the combining comprising:
      applying a linear transformation to each vector defining each word embedding to obtain a plurality of transformed vectors, wherein the plurality of transformed vectors belong to a mutually orthogonal or mutually near-orthogonal basis; and
      summing the plurality of transformed vectors to obtain the unique vector embedding,
   wherein the unique vector embedding uniquely defines the received segment and is arranged to be input into a language model.
2. The method of clause 1, wherein each linear transformation is defined by a different multi-dimensional vector thereby forming a plurality of multi-dimensional vectors, wherein the plurality of multi-dimensional vectors are mutually orthogonal or mutually near-orthogonal.
3. The method of clause 1 or 2, further comprising:
   determining a segment structure embedding of the received segment by:
      identifying a word-category for each word in the received segment, thereby obtaining a sequence of word-categories;
      determining a category-token value for the sequence of word-categories;
      encoding the category-token value as a vector defining the segment structure embedding; and
      summing the segment structure embedding with the summed plurality of transformed vectors to obtain the unique vector embedding.
   [wherein the identifying is based on a based on the predetermined syntax for the segment]
4. The method of clause 1 or 2, wherein determining the unique vector embedding further comprises:
   determining a positional encoding for each word in the segment;
   encoding each positional encoding to obtain, for each word, a vector representing a position embedding; and
   for each word, prior to applying the linear transformation to each vector defining each word embedding, summing the positional embedding with the word embedding associated with the word.

Yet another aspect of the present disclosure may be understood with reference to the following clauses, which relate to a method of decoding a vector embedding using aspects of the presently disclosed tokeniser:
1. A method of decoding a vector embedding generated by a language model to obtain a segment of a structured language, wherein the segment of the structured language comprises a plurality of words and is formed using a predetermined syntax, the method comprising:
   converting the vector embedding into a structural probability distribution representing a structural tokeniser vocabulary, the structural tokeniser vocabulary representing all possible segment structures;
   sampling the probability distribution to obtain a segment structure, wherein the segment structure contains one or more word-categories identified by placeholders;
   obtaining one or more word embeddings by, for each of the one or more word categories identified in the segment structure:
      applying a linear transformation to the vector embedding to obtain a word embedding, wherein the linear transformation is associated with a position of the word category identified in the segment structure;
   obtaining one or more words corresponding to the one or more word-categories by, for each of the one or more word embeddings:
      converting the word embedding into a word probability distribution representing a word vocabulary;
      in dependence on the identified word-category, sample the word probability distribution to obtain a word;
   obtaining the segment of the structured language in dependence on the segment structure and the one or more sampled words.
2. The method of clause 1 wherein obtaining the segment of the structured language comprises arranging the one or more sampled words in an order identified by the segment structure, or combining the one or more sampled words in dependence on the segment structure.
3. The method of clause 1 or 2, wherein sampling the word probability distribution to obtain a word in dependence on the identified word-category comprises:
   for each word probability distribution, determining a subset of words that do not belong in the identified word category associated with that word probability distribution;
   for each word in the subset of words, set a probability to zero to thereby obtain a masked probability distribution;
   sampling from the masked probability distribution to thereby obtain the word.
4. The method of any preceding clause, wherein converting the vector embedding into a structural probability distribution representing a structural tokeniser vocabulary comprises:
   multiplying the vector embedding with a structural matrix arranged to transform the vector embedding to a vector of logit values, the logit values representing possible segment structures;
   normalising the vector of logit values to obtain the structural probability distribution.
5. The method of any preceding clause, wherein the segment structure identifies at least one word in addition to the one or more word-categories, and wherein the segment of the structured language is formed by arranging the at least one word with the one or more sampled in an order identified by the segment structure.
6. The method of any preceding clause, wherein the word vocabulary represents all possible words within the structured language.
7. The method of any preceding clause, wherein the language model is a generative language model configured to generate one or more new segments in dependence on the unique vector embedding.
8. The method of any preceding clause, wherein obtaining the one or more word embeddings comprises:
   determining a word-type for each word-category identified in the segment structure;
   prior to applying each linear transformation for each of the word-categories, determining a which linear transformation to apply in dependence on the word-type determined for the word-category.

What is claimed is:

1. A method of tokenising a structured language for use in a language model, wherein the structured language is formed of segments, and wherein each segment comprises a plurality of words and is formed using a predetermined syntax, the method comprising:
receiving a segment to tokenise;
determining a segment structure embedding of the received segment by:
identifying, based on the predetermined syntax, a word-category for each word in the received segment, thereby obtaining a sequence of word-categories;
determining a category-token value for the sequence of word-categories;
encoding the category-token value as a vector defining the segment structure embedding;
determining one or more word embeddings by, for each of one or more words in the segment:
determining a word-token value for the word; and
encoding the word-token value as a vector defining a word embedding; and
determining a unique vector embedding by combining i) the vector defining the segment structure embedding and ii) each vector defining each word embedding of the one or more word embeddings, wherein the unique vector embedding uniquely defines the received segment and is arranged to be input into language model.

2. The method of claim 1, wherein the unique vector embedding is configured to be interpretable by the language model to thereby enable the language model to determine a structure of the segment and the words comprised within the segment.

3. The method of claim 1, wherein the language model is a generative language model configured to generate one or more new segments in dependence on the unique vector embedding.

4. The method of claim 1, wherein each of i) the vector defining the segment structure embedding, and ii) each vector defining each word embedding, are substantially orthogonal, and wherein determining the unique vector embedding comprises linearly combining each of i) the vector defining the segment structure embedding, and ii) each vector defining each word embedding.

5. The method of claim 3, wherein determining the unique vector embedding comprises:
applying a linear transformation to each of i) the vector defining the segment structure embedding, and ii) each vector defining each word embedding to obtain a plurality of transformed vectors, wherein each linear transformation is different; and
linearly combining the plurality of transformed vectors to obtain the unique vector embedding.

6. The method of claim 1, wherein a number of words comprised within the segment is equal to or less than a predetermined segment word-limit defined by the structured language.

7. The method of claim 5, wherein a tokeniser vocabulary is defined by a number of different possible combinations and permutations of word-categories for a segment, and wherein the tokeniser vocabulary is less than a number of possible segments formable within the structured language.

8. The method of claim 1, wherein each word of the plurality of words is either a string or a number.

9. The method of claim 8, wherein, for a word in the segment that is a string, determining the word-token value for the string comprises:
determining the word-token value for the string;
encoding, using a word embedding function, the word-token value to obtain a first intermediate embedding;
encoding, using a number embedding function, the word-token value to obtain a second intermediate embedding, wherein the second intermediate embedding represents a special token indicating that an identity of the work-token is outside a vocabulary of the number embedding function; and
combining the first intermediate embedding and the second intermediate embedding to obtain the vector defining the word embedding.

10. The method of claim 8, wherein, for a word in the segment that is a number, determining the word-token value for the number comprises:
partitioning digits of the number into a plurality of subsections, each subsection comprising one or more characters;
for each subsection of the plurality of subsections, obtaining a word-token value for the subsection and encoding, using a number embedding function, the word-token value for the subsection into an intermediate tensor of values;
combining each tensor of values, for each subsection, to obtain the vector defining the word embedding for the number;
encoding, using a word embedding function, the word-token of the subsection to obtain an intermediate embedding representing an unknown token value; and
combining the intermediate embedding representing the unknown token value with the vector defining the word embedding for the number.

11. The method of claim 1, wherein the received segment is part of a sequence of segments, wherein determining the unique vector embedding further comprises:
encoding a position of the received segment within the ordered sequence to obtain a vector representing a position embedding; and
combining the position embedding with i) the vector defining the segment structure embedding and ii) each vector defining each word embedding of the one or more word embeddings;
determining, for each segment in the ordered sequence of segments, a unique vector embedding to thereby obtain a plurality of unique vector embeddings;
inputting the plurality of unique vector embeddings into the language model; and
obtaining, from the language model, a generated segment, wherein the generated segment comprises a plurality of words arranged using the predetermined syntax.

12. The method of claim 11, further comprising:
obtaining, from the language model, an output vector representing a probability distribution over a tokeniser vocabulary, wherein the tokeniser vocabulary is defined by a number of different possible combinations and permutations of word-categories for a segment;
determining a word-category to bias in the generated segment;
in dependence on the word-category to bias, selecting a subset of values of the output vector, wherein the subset of values define segments comprising at least one word in the word-category to exclude;
obtaining an adjusted output vector by adjusting a probability value of each value in the subset of values in dependence on a bias indication; and
determining the generated segment by sampling the adjusted output vector.

13. The method of claim 11, wherein determining the generated segment by sampling the adjusted output vector comprises:
obtaining a vector embedding from the language model;
converting the vector embedding into a structural probability distribution representing a structural tokeniser vocabulary, the structural tokeniser vocabulary representing all possible segment structures;
obtaining one or more word embeddings by, for each of the one or more word categories identified in the segment structure:
applying a linear transformation to the vector embedding to obtain a word embedding, wherein the linear transformation is associated with a position of the word category identified in the segment structure;
obtaining one or more words corresponding to the one or more word-categories by, for each of the one or more word embeddings:
converting the word embedding into a word probability distribution representing a word vocabulary;
in dependence on the identified word-category, sample the word probability distribution to obtain a word; and
obtaining the segment of the structured language in dependence on the segment structure and the one or more sampled words.

14. The method of claim 13, wherein sampling the word probability distribution to obtain a word in dependence on the identified word-category comprises:
for each word probability distribution, determining a subset of words that do not belong in the identified word category associated with that word probability distribution;
for each word in the subset of words, set a probability to zero to thereby obtain a masked probability distribution; and
sampling from the masked probability distribution to thereby obtain the word.

15. The method of claim 1, wherein each word in the segment has a word-type, wherein the word-type is one of: an operator, an operand, and a number, and wherein each word-type comprises one or more possible word-categories, and wherein the structured language is an assembly language for a CPU, and each segment is a single assembly instruction, wherein the CPU uses a RISC microprocessor architecture, and wherein each segment is an assembly instruction for the RISC microprocessor architecture.

16. The method of claim 15, wherein determining the segment structure embedding is performed using a structure tokeniser, and determining the plurality of word embeddings is performed using a word tokeniser, wherein a token vocabulary of the structure tokeniser comprises all possible combinations and permutations of word-categories for a segment, and wherein a token vocabulary of the word tokeniser comprises all possible operators and operands.

17. A tokeniser unit for tokenising a structured language for use in a language model, wherein the structured language is formed of segments, and wherein each segment comprises a plurality of words and is formed using a predetermined syntax, the tokeniser unit being configured to:
receive a segment to tokenise;
determine a segment structure embedding of the received segment by:
identifying, based on the predetermined syntax, a word-category for each word in the received segment, thereby obtaining a sequence of word-categories;
determining a category-token value for the sequence of word-categories;
encoding the category-token value as a vector defining the segment structure embedding;
determine one or more word embeddings by, for each of one or more words in the segment:
determining a word-token value for the word; and
encoding the word-token value as a vector defining the word embedding; and
determine a unique vector embedding by combining i) the vector defining the segment structure embedding and ii) each vector defining each word embedding of the one or more word embeddings, wherein the unique vector embedding uniquely defines the received segment and is arranged to be input into a language model.

18. The tokeniser unit of claim 17, wherein the tokeniser unit comprises:
a structure tokeniser configured to determine the segment structure embedding; and
a word tokeniser configured to determine the plurality of word embeddings;
wherein a token vocabulary of the structure tokeniser comprises all possible word-categories, and wherein a token vocabulary of the word tokeniser comprises all possible operators and operands.

19. The tokeniser unit of claim 17, wherein the tokeniser unit comprises a tokeniser vocabulary is defined by a number of different possible combinations and permutations of word-categories for a segment, wherein the tokeniser vocabulary is less than a number of possible unique vector embeddings.

20. A non-transitory computer readable storage medium having stored thereon computer readable code configured to cause a method of tokenising a structured language for use in a language model to be performed when the code is run, wherein the structured language is formed of segments, and wherein each segment comprises a plurality of words and is formed using a predetermined syntax, the method comprising:
receiving a segment to tokenise;
determining a segment structure embedding of the received segment by:
identifying, based on the predetermined syntax, a word-category for each word in the received segment, thereby obtaining a sequence of word-categories;
determining a category-token value for the sequence of word-categories;
encoding the category-token value as a vector defining the segment structure embedding;
determining one or more word embeddings by, for each of one or more words in the segment:
determining a word-token value for the word; and
encoding the word-token value as a vector defining a word embedding; and
determining a unique vector embedding by combining i) the vector defining the segment structure embedding and ii) each vector defining each word embedding of the one or more word embeddings, wherein the unique vector embedding uniquely defines the received segment and is arranged to be input into language model.
